(19) United States
(12) Patent Application Publication
(10) Pub. No.: US 2007/0035403 A1
(43) Pub. Date: Feb. 15, 2007

(54) Method and system of personal healthcare management

(76) Inventors: Sudhir Sitaram Krishna, Sunnyvale, CA (US); Shankar Gopalkrishnan Iyer, Cupertino, CA (US)

Correspondence Address: Raj Abhyanker, LLP;c/o Intellevate, P.O. Box 52050, Minneapolis, MN, 55402, US

(21) Appl. No.: 11/503,092

(22) Filed: Aug. 11, 2006

Related U.S. Application Data
(60) Provisional application No. 60/707,818, filed on Aug. 12, 2005.
(60) Provisional application No. 60/719,403, filed on Sep. 22, 2005.
(60) Provisional application No. 60/741,408, filed on Dec. 1, 2005.

(51) Int. Cl. G08B 23/00

(52) U.S. Cl. 340/573.1

(57) ABSTRACT

A method, apparatus and system of personal healthcare management are disclosed. In one embodiment, a method includes storing a crisis relevant data of a user of a personal communication module on the personal communication module, routing an emergency signal of the user from the personal communication module to a dispatch center, and automatically communicating the crisis relevant data to the dispatch center through the personal communication module. The method may include electronically communicating through the dispatch center the crisis relevant data of the user to a first responder without manual reentry by the dispatch center. In addition, the method may include processing a communication of a health aggregation system to update the crisis relevant data when the system updates a heath history data of the user based on a healthcare provider of the user providing a revised health data of the user through middleware conversion layer(s).

### PRIORITY CLAIM

This disclosure claims priority from U.S. provisional patent application No. 60/707,818, filed on Aug. 12, 2005, U.S. provisional patent application No. 60/719,403, filed on Sep. 22, 2005, and U.S. provisional patent application No. 60/741,408, filed on Dec. 1, 2005.

### FIELD OF TECHNOLOGY

This disclosure relates generally to the technical fields of a method, apparatus and system of personal healthcare management.

### BACKGROUND

A health care provider (e.g., a doctor, a pharmacist, a dentist, etc.) may provide services to a group of patients. The health care provider may submit paper receipts and/or printed data of relevant health information to a particular patient of the group of patients. In an emergency scenario, the particular patient may use a personal communication device (e.g., a mobile telephone, a personal digital assistant, etc.) to contact a dispatch center (e.g., a 911 call center) rather than the health care provider.

The dispatch center may not be in a position to obtain critical health information of the particular patient in a timely manner (e.g., may need to be done manually). The particular patient may be of ill health and may not be able to communicate clearly and/or accurately critical information regarding his/her health to the dispatch center. Furthermore, the particular patient may not remember adverse effects and/or relevant health related details.

As such, the dispatch center may need to aggregate data laboriously from the health care provider and/or other health care providers (e.g., past and/or present) of the particular patient in order to provide care to the particular patient in the emergency scenario. The dispatch center may need to communicate this information through human interaction with a first responder (e.g., an ambulance, a paramedic, a fire department) that may be among a first to reach the particular patient. If the first responder does not receive a critical health information before they arrive at a physical location of the particular patient, the first responder may need to physically search a premise for medical records and/or medicines.

Alternatively, the first responder may need to rely on information collected from family, friends, witnesses, etc. in close proximity to a physical location of the particular patient. If the first responder is unable to get necessary information in the timely manner, the particular patient may suffer more harm than otherwise, and/or may be accidentally administered with a potentially fatal medical treatment.

### SUMMARY

A method, apparatus and system of personal healthcare management are disclosed. In one aspect, a method includes storing a crisis relevant data of a user of a personal communication module on the personal communication module, routing an emergency signal of the user from the personal communication module to a dispatch center, and automatically communicating the crisis relevant data to the dispatch center through the personal communication module.

The method may further include electronically communicating through the dispatch center the crisis relevant data of the user to a first responder (e.g., the crisis relevant data may aid the first responder in assessing a condition of the user in an emergency scenario) without manual reentry (e.g., and/or communication) by the dispatch center. The method may also include processing a communication of a health aggregation system (e.g., the health aggregation system may include a legal health data of the user having a healthcare power of attorney, a will, a trust, and/or other relevant corpus and res data of the user) to update (e.g., and/or synchronize) the crisis relevant data when the health aggregation system updates (e.g., and/or synchronizes) a health history data of the user based on a healthcare provider of the user providing a revised health data of the user (e.g., a reminder data may be also provided based on an appointment schedule between the healthcare provider and the user maintained by the health aggregation system) through middleware conversion layer(s).

The method may include providing the reminder data to the user based on an actual use data of a pharmaceutical substance communicated by the user to the personal communication module. For example, the reminder data may be again presented after a preset interval when a snooze algorithm is applied to the reminder data through a response of the user. The method may further include providing an interface to the user to reorder the pharmaceutical substance based on the actual use data, a projected calculation based on an initial input of dosage and pills, and/or a regimen defined by the user and/or the healthcare provider. The method may also include generating an alert data to the healthcare provider based on noncompliance with the regimen. Furthermore, the method may include segmenting through the health aggregation system a portion of the health history data of the user to create the crisis relevant data, an archival data, and/or a current data.

The method may include enabling the user of the personal communication module to access the crisis relevant data, the archival data, and/or the current data directly through the personal communication module whenever the user communicates a request of the crisis relevant data, the archival data, and/or the current data to the personal communication module. The method may further include restricting access to the crisis relevant data, the archival data, and/or the current data based on a security algorithm that identifies an operator of the personal communication module as being the user associated with the crisis relevant data, the archival data, and/or the current data.

The method may include applying the security algorithm using a biometric information provided by the operator of the personal communication module including at an auditory data, a visual data, and/or a tactile data. The method may include devising the security algorithm to comply with one or more governmental regulations in a jurisdiction in which the personal communication module is presently located. The method may also include automatically determining a present location of the personal communication module through a global positioning algorithm.

The method may further include automatically selecting the security algorithm currently activated on the personal communication module based on the one or more governmental regulations. The method may include providing an acute care guidance data to the user when a real time response data of a test provided to the user through an external device (e.g., the external device may be a blood pressure measurement device, a blood sugar measurement device, a temperature monitoring device, a heart rate monitoring device, a blood oxygenation device, a vital sign measuring device, and/or a sensory measurement device) that interfaces (e.g., wirelessly or otherwise) with the personal communication module is processed by the personal communication module. A recommendation to the user may be revised through the personal communication module based on an automatic analysis of the real time response data. The method may include providing an expense tracking data and/or an insurance coverage data to the user including a monthly premium data, a deductible data, a co-pay data, a pre-approval data, a coverage data, a group plan data, an affiliate and partner data, a health savings account data and/or a claim filing data.

The method may include providing an electronic payment technology directly through the personal communication module through an integrated interface having an expense tracking data and/or the insurance coverage data to enable the user to remit payment to a service provider. The method may also include providing a diet and/or exercise data to the user of the personal communication module to enhance wellness of the user of the personal communication module, and/or providing a trend reporting data to the user of the personal communication module based on an analysis of changes to a health data of the user.

In addition, the method may include providing a consultation system (e.g.,) to the user through a treatment workflow provided by a reputed authority and organized based on a module that can be navigable by the user in which the health care provider is electronically and automatically contacted based on at least one response of the user to the treatment workflow. Further, a transcript of response to the consultation system by the user can be automatically provided to the health care provider. The consultation system may automatically display certain modules of the treatment workflow in a more quickly accessible location on the personal communication module through an analysis of historical navigation and selection data of the user. A symptom list may be created automatically, based on an outbreak in a geographic area of a virus, bacteria, and/or health alert. A travel advisory may be provided through the consultation system to the user based on a geographic positioning system in the personal communication module.

In another aspect, a personal communication module includes a crisis module having an emergency relevant data of a primary user of the personal communication module, an update module to automatically bring up to date (e.g., and/or synchronize) the emergency relevant data based on a communication with a health vault module having profile information of multiple patients including the primary user of the personal communication module, and/or a routing module to automatically communicate the emergency relevant data to a dispatch center and/or a first responder when an emergency situation is detected by the personal communication module.

The health vault module may aggregate health data of the primary user from multiple historical and/or current health care providers of the primary user. Each of the historical and/or current health care providers may be provided with a tailored interface module to provide a health data of the primary user to the health vault module. Any of the health data of the primary user may be accessible by the primary user through the personal communication module (e.g., land line phone, cell phone, SMS etc).

In yet another aspect, a system includes any number of health care providers of a user to each share a crisis relevant data, an archival data, and a current data of the user with a health vault module, a network, and/or a personal communication module carried on a person of the user to communicate with the health vault module through the network, and through which is provided the crisis relevant data, the archival data, and/or the current data to the user on demand of the user through the personal communication module.

In addition, a dispatch center may automatically process the crisis relevant data of the user when the dispatch center is notified of an emergency situation affecting the user of the personal communication module. The health vault module may provide a diet and exercise data to the user of the personal communication module to enhance wellness of the user of the personal communication module. The health vault module may provide a trend reporting data to the user of the personal communication module based on an analysis of changes to a health data of the user that may be voluntarily inputted by the user and/or provided by any number of health providers to the health vault module.

The method may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a health vault module coupled to health care provider modules communicating with a personal communication module and a dispatch center module through a network, according to one embodiment.

FIG. 2 is an exploded view of the personal communication module of FIG. 1, according to one embodiment.

FIG. 3 is an exploded view of the health vault module of FIG. 1, according to one embodiment.

FIG. 4 is a table view of a patient profile table, according to one embodiment.

FIG. 5 is a user interface view of the dispatch center module of FIG. 1, according to one embodiment.

FIG. 6 is a diagrammatic system view of a data processing system in which any of the embodiments disclosed herein may be performed, according to one embodiment.

FIG. 7 is a structural view of a personal health care management system site map, according to one embodiment.

FIG. 8 is a system view 800 of the health vault module of FIG. 1 communicating with the personal communication module of FIG. 1 and the health care providers of FIG. 1 through the network of FIG. 1, according to one embodiment.

FIG. 9 is a mailbox view of the health vault module of FIG. 1, according to one embodiment.

FIG. 10 is a decision tree view of advice on dizziness, according to one embodiment.

FIG. 11 is a decision tree view of advice on chest pain, according to one embodiment.

FIG. 12 is a decision tree view of advice on emergency first aid, according to one embodiment.

FIG. 13 is a decision tree view of advice on heart attack, cardiac arrest, and Cardio-Pulmonary Resuscitation (CPR), according to one embodiment.

FIGS. 14A-C are user interface flows of the personal communication module of FIG. 1 illustrating an e-consultation process, according to one embodiment.

FIG. 15 is a user interface view of the personal communication module of FIG. 1 illustrating an appointment calendar, according to one embodiment.

FIG. 16 a user interface view of the personal communication module of FIG. 1 illustrating a wellness analysis, according to one embodiment.

FIG. 17 is a process flow of storing a crisis relevant data of a user of a personal communication module on the personal communication module, according to one embodiment.

FIG. 18 is a continuation process flow of FIG. 17 illustrating additional processes, according to one embodiment.

FIG. 19 is a continuation process flow of FIG. 18 illustrating additional processes, according to one embodiment.

FIG. 20 is a continuation process flow of FIG. 19 illustrating additional processes, according to one embodiment.

Other features of the present embodiments will be apparent from the accompanying drawings and from the detailed description that follows.

### DETAILED DESCRIPTION

A method, apparatus and system of personal healthcare management are disclosed. Although the present embodiments have been described with reference to specific example embodiments, it will be evident that various modifications and changes may be made to these embodiments without departing from the broader spirit and scope of the various embodiments.

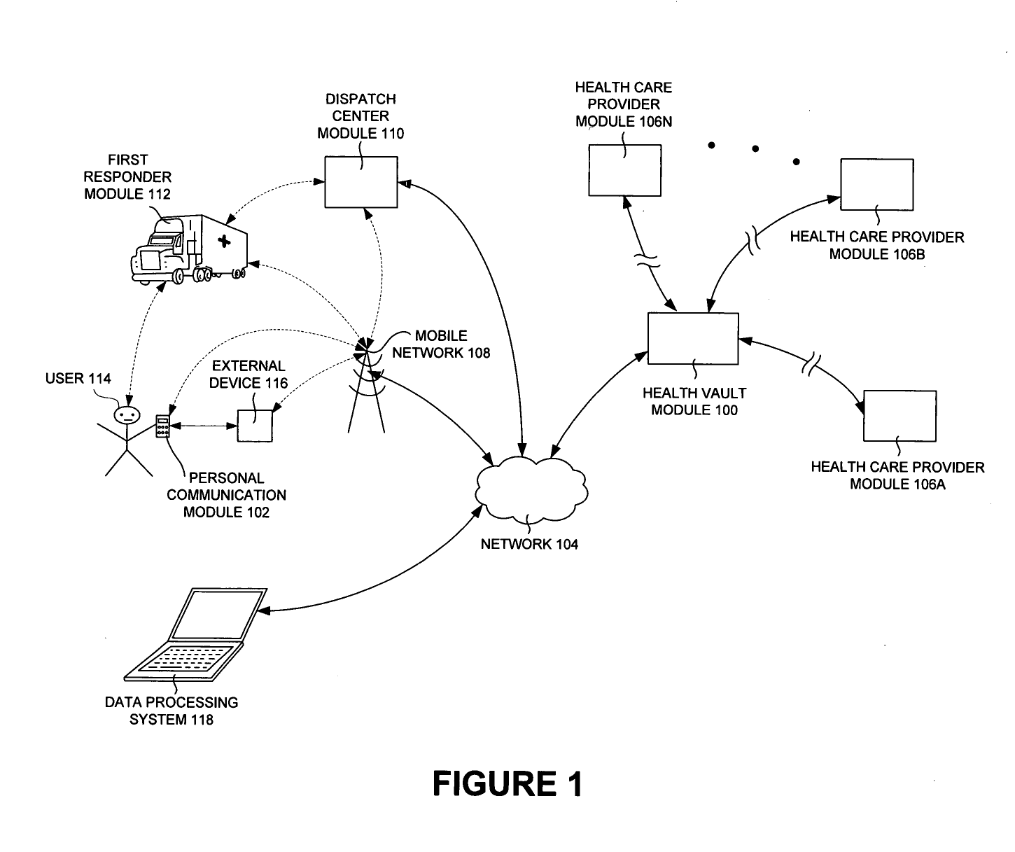

For example, according to one embodiment, a method includes storing a crisis relevant data of a user (e.g., a user 114 of FIG. 1) of a personal communication module (e.g., a personal communication module 102 of FIG. 1) on the personal communication module, routing an emergency signal of the user from the personal communication module to a dispatch center (e.g., a dispatch center module 110 of FIG. 1), and automatically communicating the crisis relevant data to the dispatch center through the personal communication module.

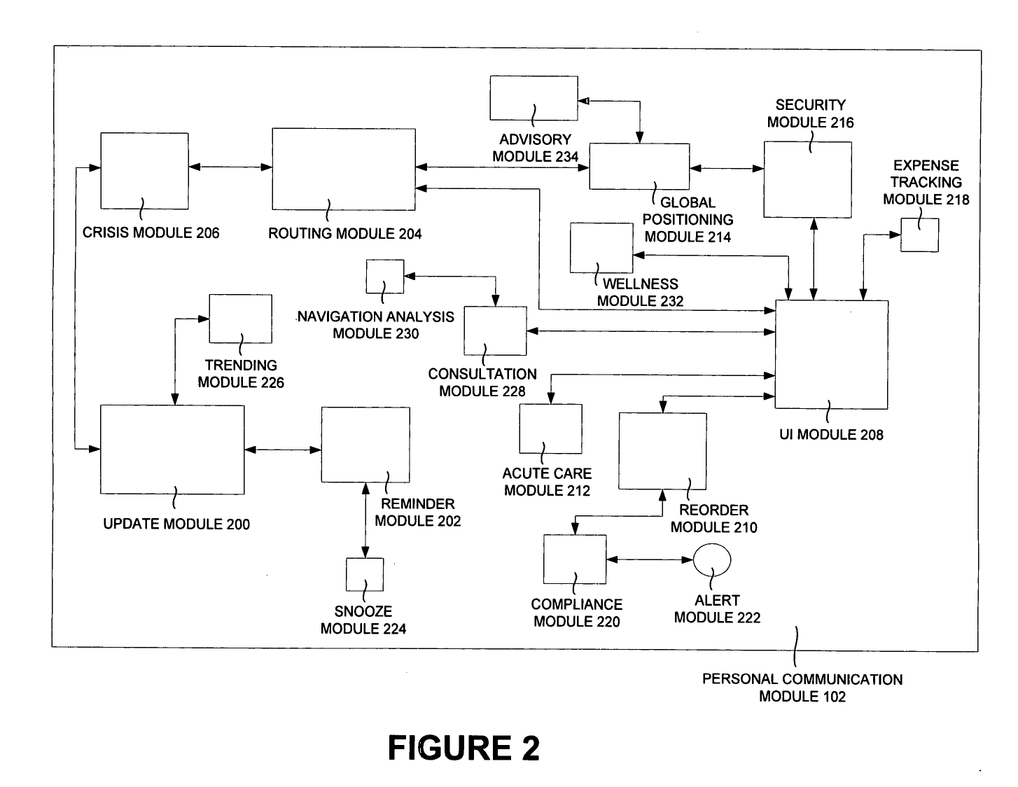

In another embodiment, a personal communication module (e.g., a personal communication module 102 of FIG. 2) includes a crisis module (e.g., a crisis module 206 of FIG. 2) having an emergency relevant data of a primary user of the personal communication module, an update module (e.g., a update module 200 of FIG. 2) to automatically bring up to date (e.g., and/or synchronize) the emergency relevant data based on a communication with a health vault module (e.g., a health vault module 100 as illustrated in FIG. 1) having profile information of a plurality of patients including the primary user of the personal communication module, and a routing module to automatically communicate the emergency relevant data to at least one of a dispatch center and a first responder when an emergency situation is detected by the personal communication module.

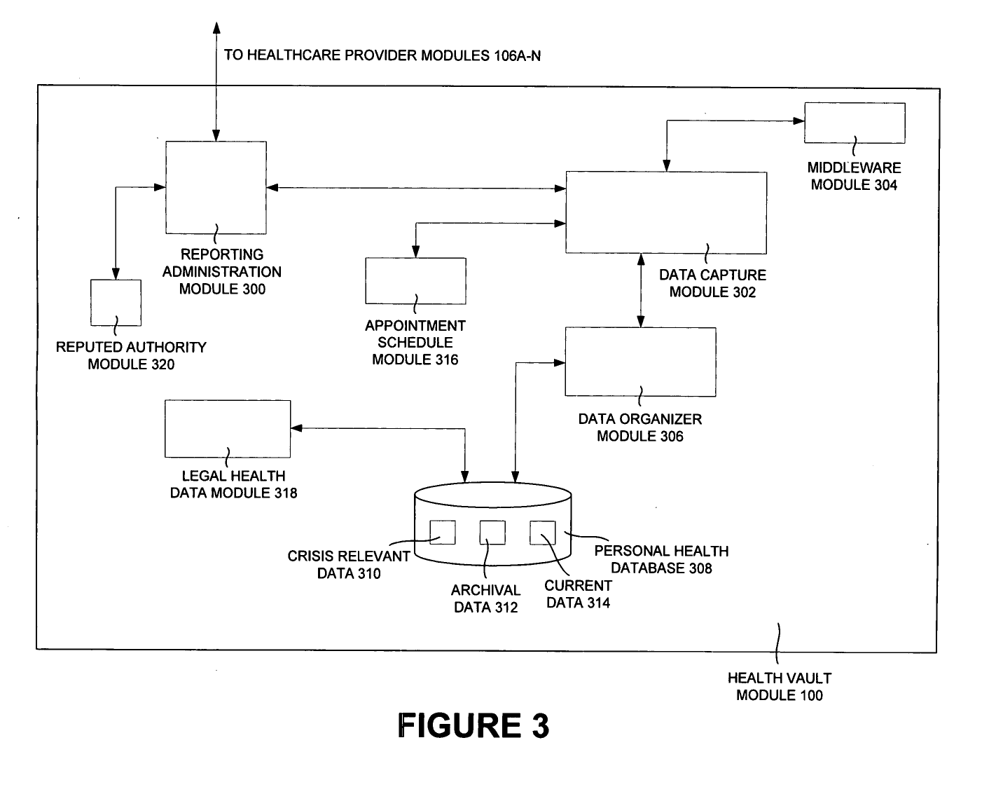

In yet another embodiment, a system includes a plurality of health care providers of a user (e.g., associated with health care modules 106) each to share a crisis relevant data, an archival data, and a current data of the user with a health vault module (e.g., as described in FIG. 3), a network (e.g., a network 104 of FIG. 1), and a personal communication module carried on a person of the user to communicate with the health vault module through the network, and through which is provided at least one of the crisis relevant data, the archival data, and the current data to the user on demand of the user through the personal communication module (e.g., as described in FIG. 3).

FIG. 1 is a system view of a health vault module 100 coupled to health care provider modules 106 communicating with a personal communication module 102 and a dispatch center module 110 through a network 104, according to one embodiment. Particularly, FIG. 1 illustrates the health vault module 100, the personal communication module 102, the network 104, the health care provider modules 106, a mobile network 108, the dispatch center module 110, a first responder module 112, a user 114, an external device 116, and a data processing system 118, according to one embodiment. The health vault module 100 may be a server and/or a computer that has physical and/or mental health condition info of the user 114. The personal communication module 102 may be a personal digital assistant, a phone, a cellular device, a wrist watch, a device on a body of the user 114, an integrated device in the body of the user 114, and/or any other device that is associated and accessible by the user 114. The health care provider modules 106 may be associated with a doctor, a pharmacist, a druggist, a nurse, a dentist, a professional, a lab, an insurance company, a hospital, etc. The mobile network 108 may be a cellular and/or a telecommunication network that transmits information wirelessly. The dispatch center module 110 may be associated with a location that receives an emergency call (e.g., a ‘911’ call center), a hospital, a senior care services provider, etc. The first responder module 112 may be an ambulance, a paramedic, someone who arrives at a crisis site first, a fire department, a first aid specialist, a police department, a security agency, etc.

The user 114 may be a senior citizen, a young adult, a child, a grown human, a physically disabled individual, a mentally challenged individual, a patient, etc. The external device 116 may be a blood pressure measurement device, a blood sugar measurement device, a temperature monitoring device, a heart rate monitoring device, a blood oxygenation device, a vital sign measuring device, and/or a sensory measurement device. The data processing system 118 may be a personal computer, a state machine, a mainframe, a server, a workstation, etc. The data processing system 118 may enable the user 114 to enter data about his/her personal health while at home (e.g., that may be later accessed through the personal communication 102).

For example, as illustrated in FIG. 1, the health vault module 100 communicates with a health care provider module 106A, a health care provider module 106B, and a healthcare provider module 106N. In addition, the health vault module 100 as illustrated in the embodiment of FIG. 1 communicates with the personal communication module through the network 104. The personal communication module 102 as illustrated in the embodiment of FIG. 1 communicates with the user 114 and the external device 116. The personal communication module 102 may communicate with the health vault module 100 through the mobile network 108. Similarly, the external device 116 may also communicate with the health vault module 100 through the mobile network 108.

In addition, the dispatch center module 110 as illustrated in the embodiment of FIG. 1 communicates with the health vault module 100, the personal communication module 102, and the data processing system 118 through the network 104. The first responder module 112 may communicate through the mobile network 108 with the health vault module 100, the personal communication module 102, and the data processing system 118. In addition, the first responder module 112 may directly communicate with the dispatch center module 110 and the user 114.

Furthermore, a crisis relevant data of a user (e.g., the user 114 of FIG. 1) of a personal communication module (e.g., the personal communication module 102 of FIG. 1) may be stored on the personal communication module 102. An emergency signal of the user 114 may be routed from the personal communication module 102 to a dispatch center (e.g., to the dispatch center module 110). The crisis relevant data 310 may be automatically communicated to the dispatch center (e.g., using the crisis module 206 of FIG. 2) through the personal communication module 102. The crisis relevant data 310 of the user may be electronically communicated through the dispatch center to a first responder (e.g., the first responder module 112 of FIG. 1) without manual reentry (e.g., and/or communication) by the dispatch center. The crisis relevant data 310 may aid the first responder in assessing a condition of the user 114 in an emergency scenario.

An external device (e.g., the external device 116 of FIG. 1) may be a blood pressure measurement device, a blood sugar measurement device, a temperature monitoring device, a heart rate monitoring device, a blood oxygenation device, a vital sign measuring device, and/or a sensory measurement device.

The health vault module 100 may aggregate health data of the primary user from any number of historical and/or current health care providers of the primary user. Each of the historical and/or current health care providers may be provided a tailored interface module (e.g., the crisis module 200 of FIG. 2) to provide the health data of the primary user to the health vault module 100.

The health data of the primary user (e.g., the user 114 of FIG. 1) may be accessible by the primary user through the personal communication module 102. Any number of health care providers of the user 114 may each share the crisis relevant data 310, an archival data 312, and/or a current data 314 of the user 114 with a health vault module 100.

For example, the personal communication module 102 may be carried on a person of the user to communicate with the health vault module 100 through the network 104, and/or through which the crisis relevant data 310, the archival data 312, and/or the current data 314 may be provided to the user 114 on demand of the user 114 through the personal communication module 102. In an alternate embodiment, the personal communication module 102 may communicate through an access point and/or through other means (e.g., radio, point to point mobile communication, infrared network, etc.).

The dispatch center module 110 may automatically process the crisis relevant data 310 of the user when the dispatch center module 110 is notified of an emergency situation affecting the user 114 of the personal communication module 102.

FIG. 2 is an exploded view of the personal communication module 102 of FIG. 1, according to one embodiment. Particularly, FIG. 2 illustrates a update module 200, a reminder module 202, a routing module 204, a crisis module 206, a user interface (UI) module 208, a reorder module 210, a acute care module 212, a global positioning module 214, a security module 216, an expense tracking module 218, a compliance module 220, an alert module 222, a snooze module 224, a trending module 226, a consultation module 228, a navigation analysis module 230, a wellness module 232, and an advisory module 234, according to one embodiment.

The update module 200 may refresh (e.g., synchronize) data associated with personal information of the user 114 through the personal communication module 102. The reminder module 202 may provide prompts, alerts etc. to the user 114 to take a medication and/or prescription. The routing module 204 may enable the personal communication module 102 to interact over the network 104. The crisis module 206 may automatically provide information to the dispatch center module 110 and/or the first responder module 112 in case of emergency. The UI module 208 may provide a graphical user interface view to the user 114 of the personal communication module 102. The reorder module 210 may enable the user 114 to repurchase, reorder, and/or submit a transaction request to a pharmacy, doctor, and/or other health care providers. The acute care module 212 may provide support in cases of severe, crisis, and/or grave health conditions through a series of automatic guidance techniques. The global positioning module 214 may provide geographic information indicating a location of the user 114 at a particular point in the world and/or a particular longitudinal and/or latitudinal place on the globe. The security module 216 may provide protection against external parties trying to access private information associated with the user 114 through a series of one or more algorithms and/or formulas that provide safety of confidential information associated with the user 114.

The expense tracking module 218 may provide information about charges that are associated with health services incurred by the user 114. The compliance module 220 may provide information about conformity, observance, submission to a medical and/or prescription regimen authorized by a health care provider to the user 114. The alert module 222 may provide a series of notifications in case of health adversities to the user 114 (e.g., automatically detected and/or user initiated). The snooze module 224 may temporarily halt a reminder and/or a notification to the user 114 for a preset and/or automatically adjustable window of time. The trending module 226 may provide information about tendencies, movement, development, leanings, etc. based on current and/or past medical history data and/or health care related data associated with the user 114.

The consultation module 228 may provide electronic and/or automatic information such as health care sessions, live chat, automated workflow direction, discussion, etc. with a reputed authority (e.g., forms of the Red Cross® and/or the American Medical Association®) and/or with a health care provider (e.g., a family doctor). The navigation analysis module 230 may be used to determine a next set of windows to reorder/display based on previous inputs of selection choices of the user 114, according to one embodiment. The wellness module 232 may be used to provide health, fitness, training, cardiovascular, anabolic, and/or catabolic information to the user 114, according to one embodiment. The advisory module 234 may be used to provide consultations and/or guidance to the user 114 automatically through the personal communication module 102, according to one embodiment.

In the example embodiment illustrated in FIG. 2, the update module 200 communicates with the reminder module 202, the crisis module 206, and the trending module 226. The reminder module 202 also communicates with the snooze module 224, and the crisis module 206 communicates with the routing module 204. In the example embodiment illustrated in FIG. 2, the routing module 204 also communicates with the UI module 208 and the global positioning module 214.

The UI module communicates with the reorder module 210, the acute care module 212, the security module 216, the expense tracking module 218, the consultation module 228, and the wellness module 232. For example, as illustrated in FIG. 2, the reorder module 210 also communicates with the compliance module 220. The global positioning module 214 interacts with the security module 216 and the advisory module 234, according to the embodiment illustrated in FIG. 2. The compliance module 220 communicates with the alert module 222. The consultation module 228 also interacts with the navigation analysis module 230 as illustrated in the example embodiment of FIG. 2.

For example, an alert data to the healthcare provider may be generated (e.g., using the alert module 222 of FIG. 2) based on noncompliance with a regimen.

Access to the crisis relevant data 310, the archival data 312, and/or the current data 314 may be restricted based on a security algorithm that identifies an operator of the personal communication module 102 as being the user 114 associated with the crisis relevant data 310, the archival data 312, and/or the current data 314.

The security algorithm may be applied using biometric information provided by the operator of the personal communication module 102 (e.g., the user 114). The biometric information may include an auditory data, a visual data, and/or a tactile data.

The security algorithm may be devised to comply with a governmental regulation in a jurisdiction in which the personal communication module 102 is presently located.

A present location of the personal communication module 102 may be automatically determined through a global positioning algorithm (e.g., using a global positioning module 214 as illustrated in FIG. 2).

The security algorithm currently activated on the personal communication module 102 may be automatically selected based on the governmental regulation.

An acute care guidance data may be provided to the user 114 when a real time response data of a test provided to the user 114 through an external device (e.g., the external device 116 of FIG. 1) that wirelessly interfaces with the personal communication module 102 is processed by the personal communication module 102.

An expense tracking data and/or an insurance coverage data may be provided to the user 114 (e.g., the expense tracking data and/or the insurance coverage data may include a monthly premium data, a deductible data, a co-pay data, a pre-approval data, a coverage data, a group plan data, an affiliate and partner data, a health savings account data and/or a claim filing data).

An electronic payment technology may be provided directly through the personal communication module 102 through an integrated interface having the expense tracking data and the insurance coverage data to enable the user to remit payment to a service provider.

A diet and exercise data may be provided to the user 114 of the personal communication module 102 to enhance wellness of the user of the personal communication module. A trend reporting data may also be provided to the user 114 of the personal communication module 102 based on an analysis of changes to a health data of the user.

A consultation system may be provided to the user through a treatment workflow provided by a reputed authority and organized based on modules that can be navigable by the user in which a health care provider (e.g., associated with the health care provider modules 106 of FIG. 1) is electronically and automatically contacted based on the response of the user to the treatment workflow.

The consultation system may automatically display certain modules of the treatment workflow in a more quickly accessible location on the personal communication module 102 through an analysis of historical navigation and/or selection data of the user 114.

A symptom list may be automatically created (e.g., based on an outbreak in a geographic area of a virus, bacteria, epidemic, and/or health alert). In an alternate embodiment, the symptom list may be created manually (e.g., by entities of a department of public health).

A travel advisory may be provided through the consultation system to the user 114 based on a geographic positioning system in the personal communication module 102 (e.g., the global positioning module 214 of FIG. 2).

A crisis module may have (e.g., may process) an emergency relevant data of a primary user 114 of the personal communication module 102.

The update module 200 may automatically bring up to date (e.g., synchronize) the emergency relevant data based on a communication with the health vault module 100 having profile information of any number of patients including the primary user 114 of the personal communication module 102. In an alternate embodiment, the personal communication module 102 (e.g., as illustrated in FIG. 2) may include a synchronization module to synchronize the emergency relevant data based on a communication with the health vault module 100).

A routing module 204 (e.g., as illustrated in FIG. 2) may automatically communicate the crisis relevant data 310 to a dispatch center and/or a first responder when an emergency situation (e.g., a crisis) is detected by the personal communication module 102.

For example, the health vault module 100 may provide a diet and exercise data (e.g., using the wellness module of FIG. 2) to the user 114 of the personal communication module 102 to enhance wellness of the user 114 of the personal communication module 102, according to one embodiment.

The health vault module 100 may also provide a trend reporting data (e.g., using the trending module 226 of FIG. 2) to the user 114 of the personal communication module 102 based on an analysis of changes to a health data of the user that is voluntarily inputted by the user and/or provided by the health providers to the health vault module 100.

FIG. 3 is an exploded view of the health vault module 100 of FIG. 1, according to one embodiment. Particularly, FIG. 3 illustrates a reporting administration module 300, a data capture module 302, a middleware module 304, a data organizer module 306, a personal health database 308, a crisis relevant data 310, an archival data 312, a current data 314, an appointment schedule module 316, a legal health data module 318, and a reputed authority module 320, according to one embodiment.

The reporting administration module 300 may be used to provide summaries and/or consolidated presentation information to the user 114 in a distilled and/or concise form. The data capture module 302 may be used to render and/or harness information from one or more sources, according to one embodiment. The middleware module 304 may provide a translation capability (e.g., of file formats from different doctors, such as through a WebMethods® and/or other XML translation schema) to the health vault module 100 of FIG. 3, according to one embodiment. The data organizer module 306 may be used to structure and/or present data to user 114, according to one embodiment. The personal health database 308 may contain information associated with confidential and/or proprietary health related data of the user 114.

The crisis relevant data 310 may be used to provide information relevant to an emergency scenario (e.g., drug reactions, current health, gender, weight, etc.). The archival data 312 may be dated health information of the user 114 (e.g., older than a threshold value of time such as older than 5 years). The current data 314 may be information relevant to health of the user 114, but seldom required in emergency scenarios. The appointment schedule module 316 may be used to keep organized health care related visits by the user 114 with one or more health care providers (e.g., doctor visits). The legal health data module 318 may be used to display information relevant to a judicial proceeding that may affect the right of the user 114 inter vivos or post vivos (e.g., during life and/or after life such as a will, a trust, a living will, etc.) The reputed authority module 320 may be used to store information about trusted and/or learned sources of information relevant to health that can be relied upon for advice (e.g., electronic consultation resources) in an emergency and/or non-emergency scenario, according to one embodiment.

In the example embodiment illustrated in FIG. 3, the reporting administration module 300 interacts with the healthcare provider modules 106 of FIG. 1 as well as the data capture module 302 and the reputed authority module 320 of FIG. 3. The data capture module 302 also communicates with the middleware module 304, the data organizer module 306 and the appointment scheduler module 316, according to the example embodiment illustrated in FIG. 3.

The data organizer module 306 communicates with the personal health database 308. The personal health database 308 also interacts with the legal health data module 318. For example, the personal health database 308 may process (e.g., communicate, capture, store, track and/or monitor, etc.) the crisis relevant data 310, the archival data 312 and the current data 314, as illustrated in FIG. 3.

A communication of a health aggregation system may be processed to update and/or synchronize the crisis relevant data when the health aggregation system updates a health history data of the user 114 based on a healthcare provider of the user 114 providing a revised health data of the user 114 through at least one middleware conversion layer (e.g., the middleware module 304 of FIG. 3). For example, the health aggregation system may include a legal health data of the user such as a healthcare power of attorney, a will, a trust, and other relevant corpus and res data of the user.

A reminder data may be provided to the user 114 (e.g., using the reminder module 202 of FIG. 2) based on an actual use data of a pharmaceutical substance communicated by the user 114 to the personal communication module 102. For example, the reminder data may be again presented after a preset interval when a snooze algorithm is applied to the reminder data (e.g., through a snooze module 224 as illustrated in FIG. 2) through a response of the user 114 (e.g., using the personal communication module 102).

The reminder data may also be provided based on an appointment schedule (e.g., maintained by the health aggregation system) between a healthcare provider (e.g., associated with the healthcare provider modules 106 of FIG. 1) and the user 114.

A portion of the health history data of the user may be segmented through the health aggregation system to create the crisis relevant data 310, an archival data 132, and/or a current data 314.

The user 114 of the personal communication module 102 may access the crisis relevant data 310, the archival data 312, and/or the current data 314 directly through the personal communication module 102 whenever the user 114 communicates a request of the crisis relevant data 310, the archival data 312, and/or the current data 314 to the personal communication module 102.

A recommendation to the user 114 may be revised through the personal communication module 102 based on an automatic analysis of the real time response data. In one embodiment, a transcript of response to the consultation system (e.g., and/or a Short Message Service (SMS) message communicated using a mobile phone and/or the internet) by the user 114 may be automatically provided to the health care provider (e.g., the health care provider associated with the health care provider modules 106 of FIG. 1). In an alternate embodiment, the health vault module 100 illustrated in FIG. 3 may include a messaging module to process (e.g., capture, analyze, generate, communicate, store and/or track, etc.) Short Message Service (SMS) messages communicated by the user 114 (e.g., using a mobile phone and/or the internet). For example, the messaging module of the health vault module 100 may communicate data and/or meta data associated with any number of Short Message Service communications by the user 114 to the health provider modules 106.

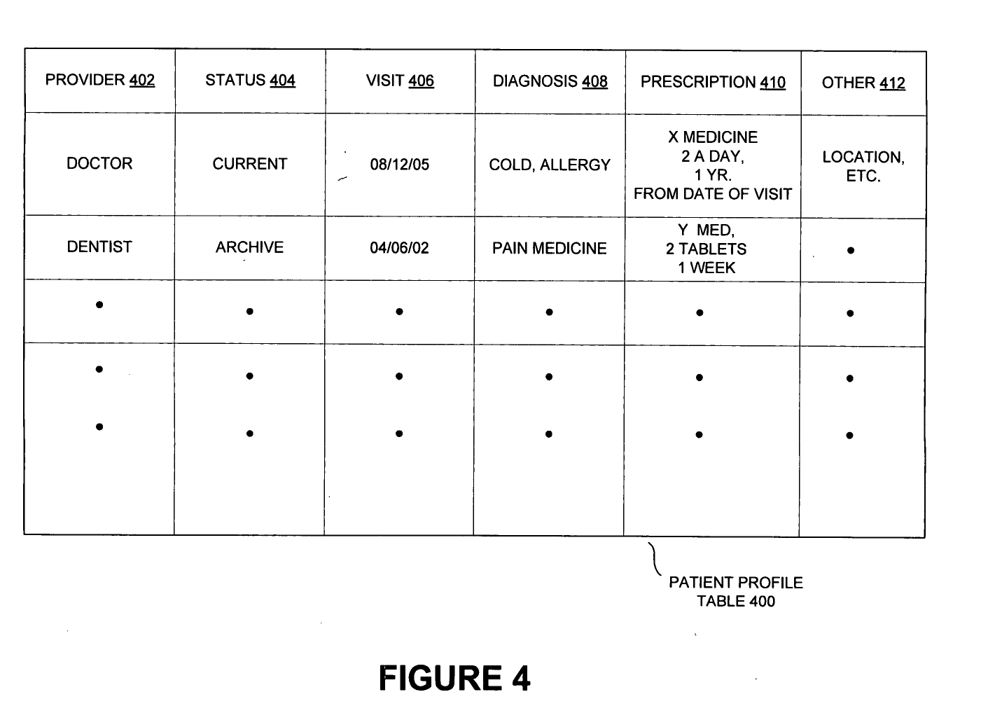

FIG. 4 is a table view of a patient profile table 400, according to one embodiment. Particularly, FIG. 4 illustrates a provider field 402, a status field 404, a visit field 406, a diagnosis field 408, a prescription field 410, and other field(s) 412, according to one embodiment. The patient profile table 400 may include information related to health care status and/or condition of a particular user 114. The provider field 402 may indicate a particular health care provider (e.g., a doctor, a dentist, etc.). The status field 404 may indicate whether the health care provider is currently providing services to the user 114. The visit field 406 may indicate previous and/or future visits scheduled between the user 114 and the health care provider. The diagnosis field 408 may indicate an overall health condition of the user 114. The prescription field 410 may indicate what kinds of medications the user 114 is currently taking and/or any health adverse effects that might affect treatment. The other field(s) 412 may indicate any other supplemental information that can be relevant to treatment and/or healing of the user 114.

The provider field 402 displays “Doctor” in the first row and “Dentist” in the second row of the provider field 402 column of the patient profile table 400 illustrated in FIG. 4.

The status field 404 displays “Current” in the first row and “Archive” in the second row of the status field 404 column of the example embodiment of the patient profile table 400 illustrated in FIG. 4. The visit field 406 displays “Aug. 12, 2005” in the first row and “Apr. 6, 2002” in the second row of the visit field 406 column. The diagnosis field 408 displays “Cold, Allergy” in the first row and “Pain Medicine” in the second row of the diagnosis field 408 column of the exemplary patient profile table 400 illustrated in FIG. 4.

The prescription field 410 displays “X Medicine, 2 a Day, 1 yr. from Date of Visit” in the first row and “Y Med, 2 tablets, 1 Week” in the second row of the prescription field 410 column. In the example embodiment illustrated in FIG. 4, the other field(s) 412 display(s) “Location, etc.” in the first row of the other(s) field 412 column.

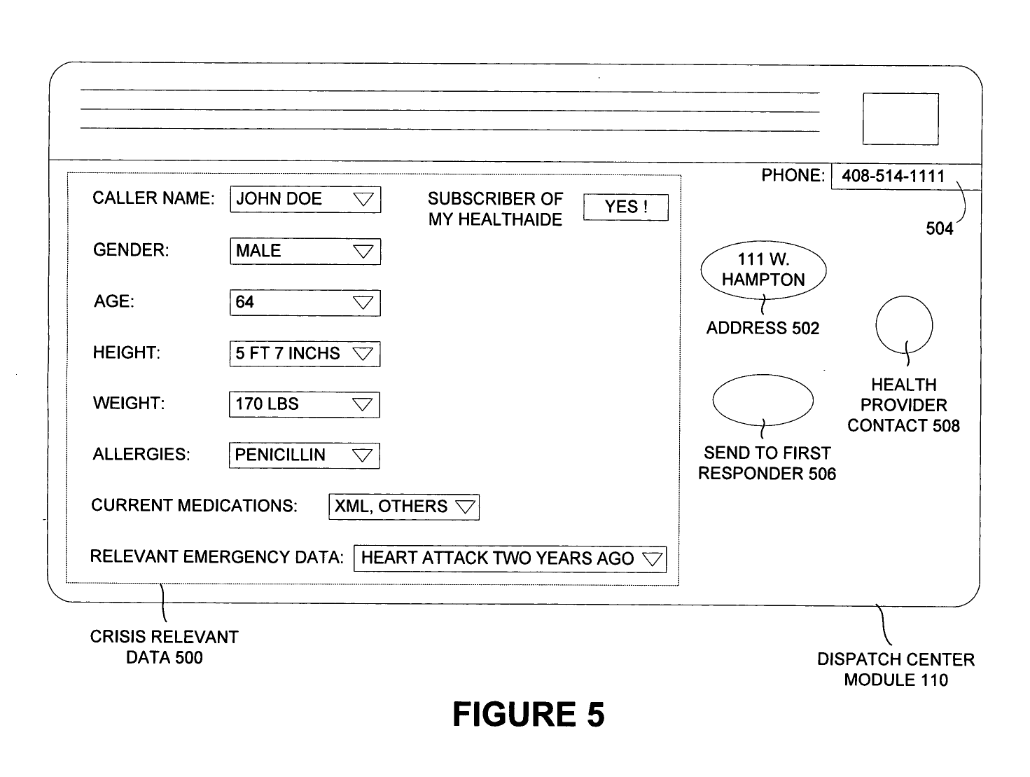

FIG. 5 is a user interface view of the dispatch center module 110 of FIG. 1, according to one embodiment. Particularly, FIG. 5 illustrates a crisis relevant data 500, an address indicator 502, a phone indicator 504, a send to first responder indicator 506, and a health provider contact indicator 508, according to one embodiment. The crisis relevant data 500 may indicate information that is relevant in an emergency situation to the dispatch center module 110. The address indicator 502 may display a particular home and/or physical address of a distressed caller (e.g., the user 114 in an emergency situation when a ‘911’ call is made through a global positioning algorithm). The phone indicator 504 may indicate a present location of the user 114 in a particular geographic area. The send to first responder indicator 506 may provider relevant information to a first responder in a health emergency of the user automatically. The health provider contact indicator 508 may display relevant health information associated with medical professionals treating (e.g., or who previously treated) the user 114.

The crisis relevant data 500 references information (e.g., data and/or meta data, statistics, personal information, biographical data, etc. associated with an entity) referenced by the dispatch center module 10 in the example embodiment illustrated in FIG. 5.

The address indicator 502 displays an identifier associated with an address (e.g., a physical location, a geographical coordinate, a map reference, etc.). For example, the phone indicator 504 displays a code (e.g., a phone number, a series of digits, an alphanumeric string, etc.) associated with a contact information of the entity referenced by the crisis relevant data 500, as illustrated in the example embodiment of FIG. 5. The send to first responder indicator 506 may display an indication of a status (e.g., a toggle state, an activation status, a link, a color code, an alert, etc.) associated with an action (e.g., a send to first responder action). The health provider contact indicator 508 may display a contact information of a health provider (e.g., associated with the health care provider modules illustrated in FIG. 1), according to one embodiment.

An interface (e.g., the reorder module 210 of FIG. 2) may be provided to the user to reorder a pharmaceutical substance (e.g., based on an actual use data, a projected calculation based on an initial input of dosage and pills, and/or a regimen defined by the user and/or the healthcare provider).

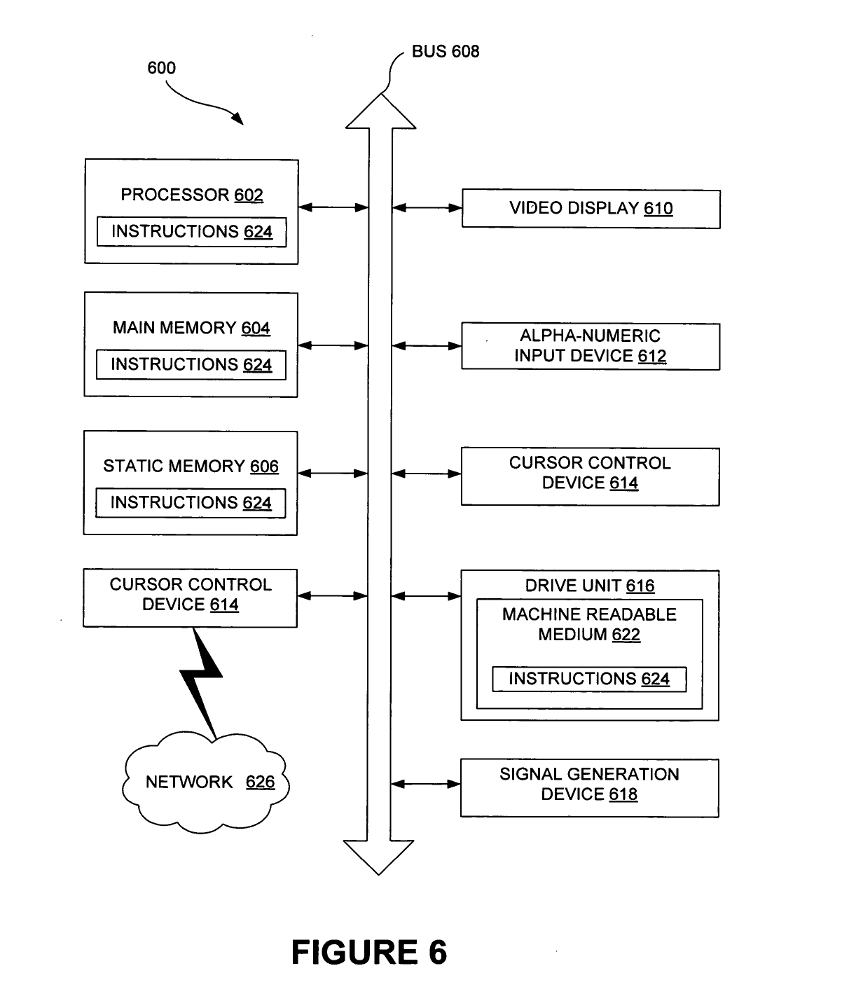

FIG. 6 is a diagrammatic system view 600 of a data processing system in which any of the embodiments disclosed herein may be performed, according to one embodiment. Particularly, the system view 600 of FIG. 6 illustrates a processor 602, a main memory 604, a static memory 606, a bus 608, a video display 610, an alpha-numeric input device 612, a cursor control device 614, a drive unit 616, a signal generation device 618, a machine readable medium 622, instructions 624, and a network 626, according to one embodiment. The diagrammatic system view 600 may indicate a personal computer and/or a data processing system in which one or more operations disclosed herein are performed. The processor 602 may be microprocessor, a state machine, an application specific integrated circuit, a field programmable gate array, etc. (e.g., Intel® Pentium® processor). The main memory 604 may be a dynamic random access memory and/or a primary memory of a computer system. The static memory 606 may be a hard drive, a flash drive, and/or other memory information associated with the data processing system. The bus 608 may be an interconnection between various circuits and/or structures of the data processing system. The video display 610 may provide graphical representation of information on the data processing system. The alpha-numeric input device 612 may be a keypad, keyboard and/or any other input device of text (e.g., a special device to aid the physically handicapped). The cursor control device 614 may be a pointing device such as a mouse.

The drive unit 616 may be a hard drive, a storage system, and/or other longer term storage subsystem. The signal generation device 618 may be a bios and/or a functional operating system of the data processing system. The machine readable medium 622 may provide instructions on which any of the methods disclosed herein may be performed. The instructions 624 may provide source code and/or data code to the processor 602 to enable any one/or more operations disclosed herein.

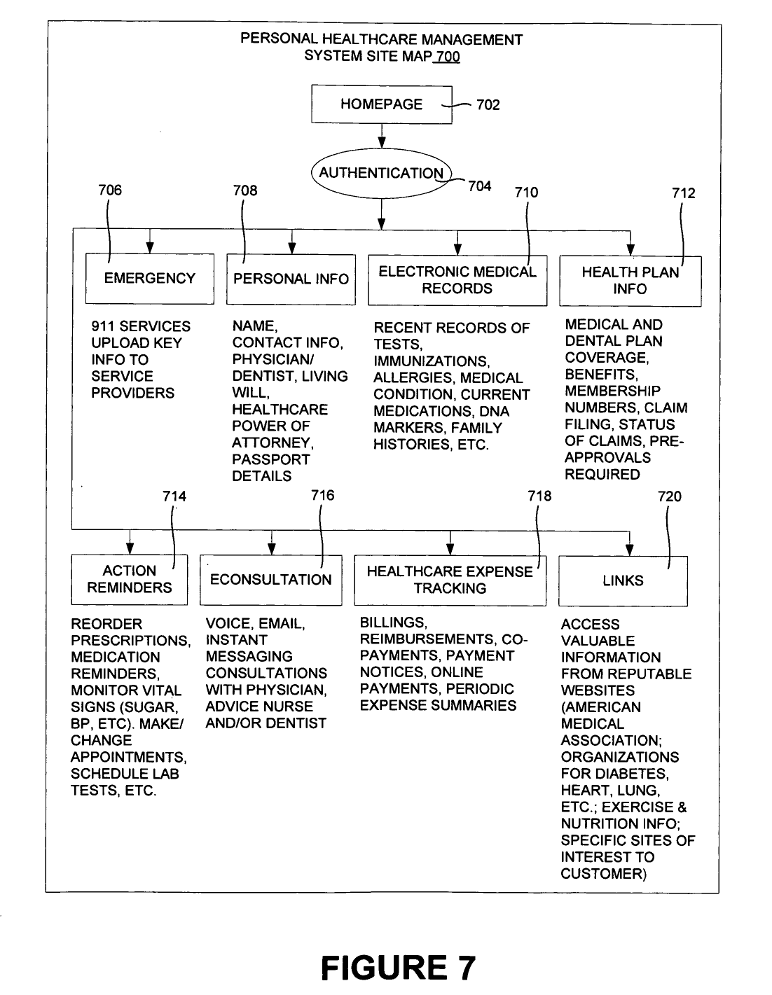

FIG. 7 is a structural view of a personal health care management system site map 700, according to one embodiment. Particularly, the personal health care management system site map 700 of FIG. 7 illustrates a homepage mark-up language data 702, an authentication mark-up language data 704, an emergency mark-up language data 706, a personal info mark-up language data 708, an electronic medical records mark-up language data 710, a health plan info mark-up language data 712, an action reminders mark-up language data 714, an econsultation mark-up language data 716, a healthcare expense tracking mark-up language data 718, and a links mark-up language data 720, according to one embodiment.

The personal healthcare management system site map 700 may be a graphical representation of a logical structuring of multiple mark-up language data forms (e.g., sites, pages, etc.) The homepage mark-up language data 702 may be associated with a personal health care management system (e.g., a software application, a mobile application, a web-based application, a software utility, etc.). The authentication mark-up language data 704 may be a data verification procedure, an identification procedure, and/or a security check (e.g., using passwords and/or access privileges), etc.

For example, the authentication mark-up language data 704 may be associated with a compliance with industry and/or governmental privacy regulations (e.g., the U.S. Health Insurance Portability and Accountability Act, etc.). The emergency mark-up language data 706 may include data, references and/or information associated with a crisis situation, an accident and/or a disaster (e.g., “911” services). The personal info mark-up language data 708 may reference identifiers and/or data associated with personal information, legal health data, biographical information and/or individual preferences, etc.

The electronic medical records mark-up language data 710 may reference data and/or meta data associated with electronically accessible archival, historical and/or current medical records (e.g., immunization records, allergies, medical condition, current medication regimens, genetic information, family history, etc.). The health plan info mark-up language data 712 may reference information associated with medical and/or dental insurance plan coverage, benefit packages, membership (e.g., registration) numbers, claim history, and/or pre-approval information (e.g., for coverage). The action reminders mark-up language data 714 may reference information associated with periodic alerts and/or notifications (e.g., reminders to reorder prescriptions, medication reminders, monitoring of vital signs, appointment and/or lab test schedules, etc.)

The econsultation mark-up language data 716 may enable voice, email, and/or instant messaging consultations between customers and health care professionals (e.g., electronic consultations with physicians, advice nurses and/or dentists, etc.). The healthcare expense tracking mark-up language data 718 may process (e.g., track, display, reference, capture, store, record and/or monitor, etc.) data and/or meta data associated with a customer's billings, reimbursements, co-payments (e.g., under coverage plans), notices, online payments and/or periodic reports (e.g., summaries of information), etc. The links mark-up language data 720 may process (e.g., reference) information associated with external resources (e.g., reputable websites, prominent medical and/or health care associations, organizations associated with specific ailments, diseases and/or disorders, diet, exercise and/or nutrition information, etc.).

For example, according to the embodiment illustrated in FIG. 7, the homepage mark-up language data 702 may process a flow referencing the authentication mark-up language data 704. The authentication mark-up language data 704 may process a flow referencing the emergency mark-up language data 706, the personal info mark-up language data 708, the electronic medical records mark-up language data 710, the health plan info mark-up language data 712, the action reminders mark-up language data 714, the econsultation mark-up language data 716, the healthcare expense tracking mark-up language data 718, and/or the links mark-up language data 720. The example embodiment of the homepage site map 702 illustrated in FIG. 7 displays information (e.g., menus, offerings, additional mark-up language data references, etc.) associated with the mark-up language data (e.g., links, pages, forms, sites, etc.) referenced by the authentication mark-up language data 704.

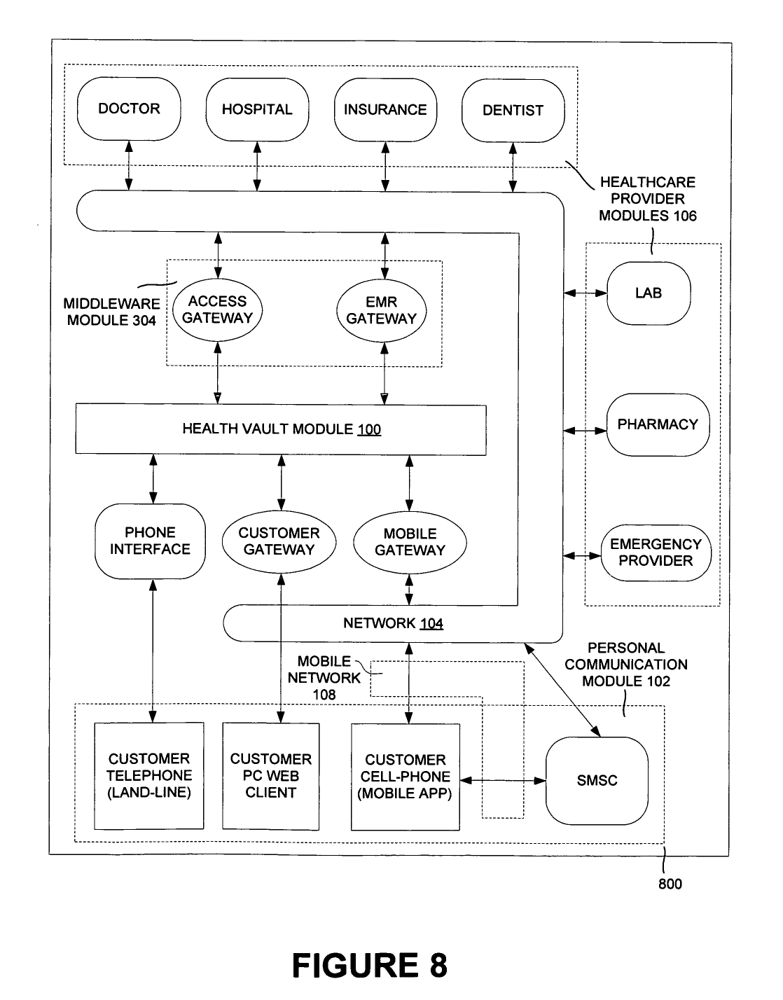

FIG. 8 is a system view 800 of the health vault module 100 of FIG. 1 communicating with the personal communication module 102 of FIG. 1 and the health care provider modules 106 of FIG. 1 through the network 104 of FIG. 1, according to one embodiment. According to the example embodiment illustrated in FIG. 8, the personal communication module 102 (e.g., the personal communication module 102 illustrated in FIG. 1) may be associated with various devices (e.g., user devices) such as a customer telephone (e.g., land-line telephone), a customer PC Web client, a customer cell-phone (e.g., mobile application), and a Short Message Service Center (e.g., SMSC).

The various devices associated with the personal communication module 102 may communicate with the healthcare provider modules 106 (e.g., the health care provider modules 106 illustrated in FIG. 1) associated with various health care providers such as a doctor, an hospital, insurance (e.g., medical insurance providers), a dentist, a lab, a pharmacy, and an emergency provider (e.g., paramedics), through the network 104 and/or the mobile network 108, the health vault module 100 and the middleware module 304 (e.g., the middleware module 304 may provide software-enabled mediation and/or integration of information across applications, databases and/or networks) as illustrated in FIG. 8.

For example, the customer telephone (e.g., land-line telephone) device communicates with the health vault module 100 (e.g., the health vault module 100 illustrated in FIG. 1) through a phone (e.g., a telecommunication) interface, as illustrated in the example embodiment of FIG. 8. The customer PC web client communicates with the health vault module through the network 104 and/or a customer gateway. The customer cell-phone (e.g., mobile application) device communicates with the health vault module 100 and/or the Short Message Service Center (e.g., SMSC) through the mobile network 108, the network 104 and/or a mobile gateway, according to the exemplary embodiment illustrated in FIG. 8.

For example, as illustrated in FIG. 8, the health vault module 100 may communicate a flow (e.g., a communication, a data flow, a stream, etc.) from the various devices associated with the personal communication module 102 to the healthcare provider modules 106 through an access gateway or an EMR gateway of the middleware module 302.

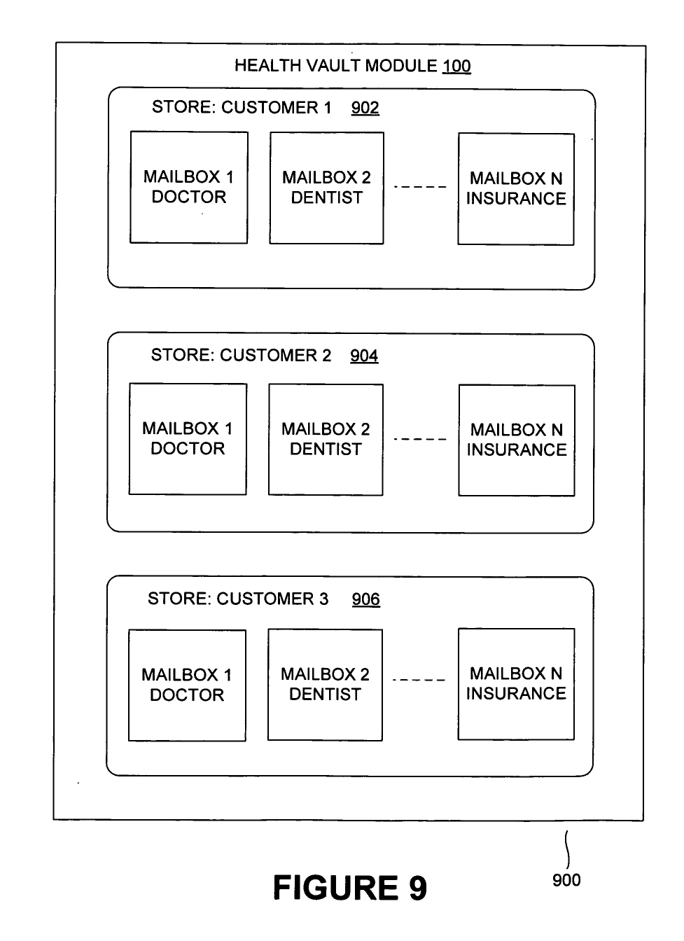

FIG. 9 is a mailbox view 900 of the health vault module 100 of FIG. 1, according to one embodiment. Particularly, the mailbox view 900 of FIG. 9 illustrates a store structure 902 (e.g., a customer 1 store), a store structure 904 (e.g., a customer 2 store), and a store structure 906 (e.g., a customer 3 store), according to one embodiment. As illustrated in the example embodiment of FIG. 9, the various store structures of the health vault module include individual mailboxes associated with different health care providers (e.g., a doctor mailbox, a dentist mailbox, and/or an insurance mailbox of the store structure 902 associated with customer 1, etc.). The store structures 902, 904 and 906 (e.g., associated with customers 1, 2, and 3 respectively, as illustrated in FIG. 9) may reference individuals who are members of and/or are subscribed to a personal health care management system (e.g., associated with the health vault module 100).

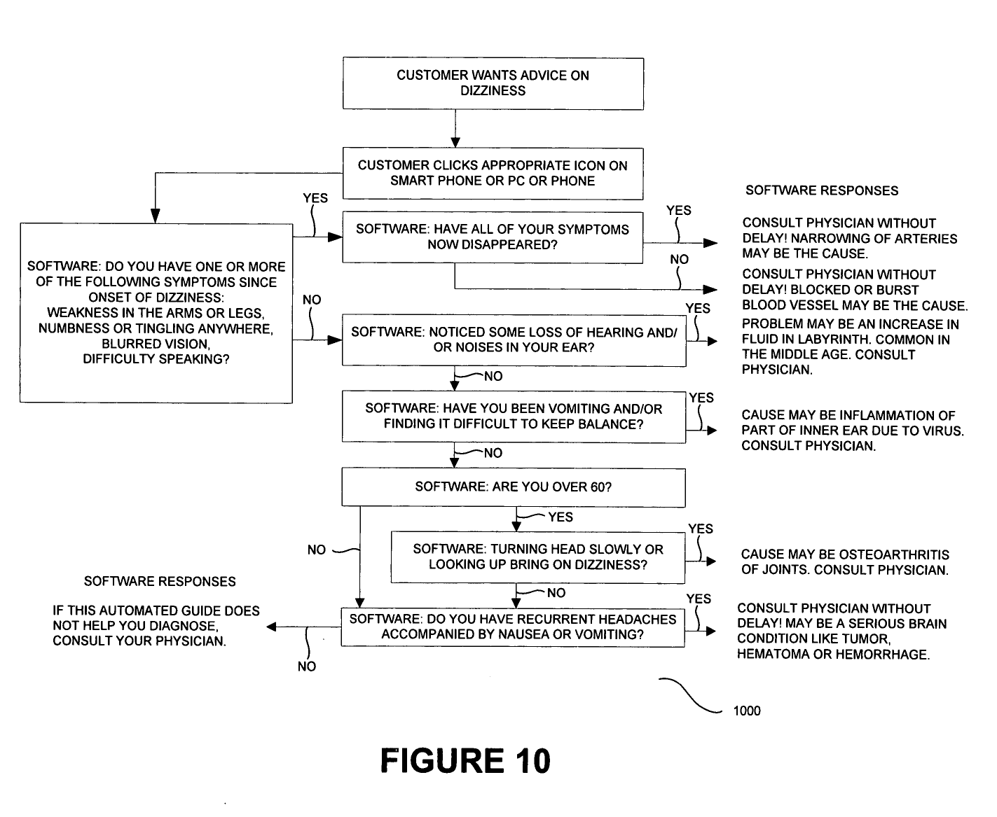

FIG. 10 is a decision tree view 1000 of advice on dizziness, according to one embodiment. The decision tree view 1000 illustrates an example embodiment of a flow of health care advice (e.g., information) based on actions and/or queries by a customer (e.g., a customer seeking health care advice on a particular symptom such as dizziness).

For example, based on an action (e.g., an action associated with selecting a health care inquiry category and/or a symptom) by the customer (e.g., communicated by the customer using a device such as a smart phone, a personal computer or a phone), a menu of choices associated with the customer's query may be generated. The menu of choices may be questions related to the query to which the customer may respond with an affirmative or negative option, as illustrated in the example embodiment of FIG. 10.

Based on the customer's responses to a cumulative and/or hierarchical sequence of choices, the decision tree view 1000 may suggest (e.g., generate using software, algorithms, links, etc.) a health care advisory action (e.g., health care advice) tailored to addressing the nature, scope, location and/or intensity of the specific symptoms identified by the customer (e.g., symptoms related to dizziness, as illustrated in the example embodiment of FIG. 10).

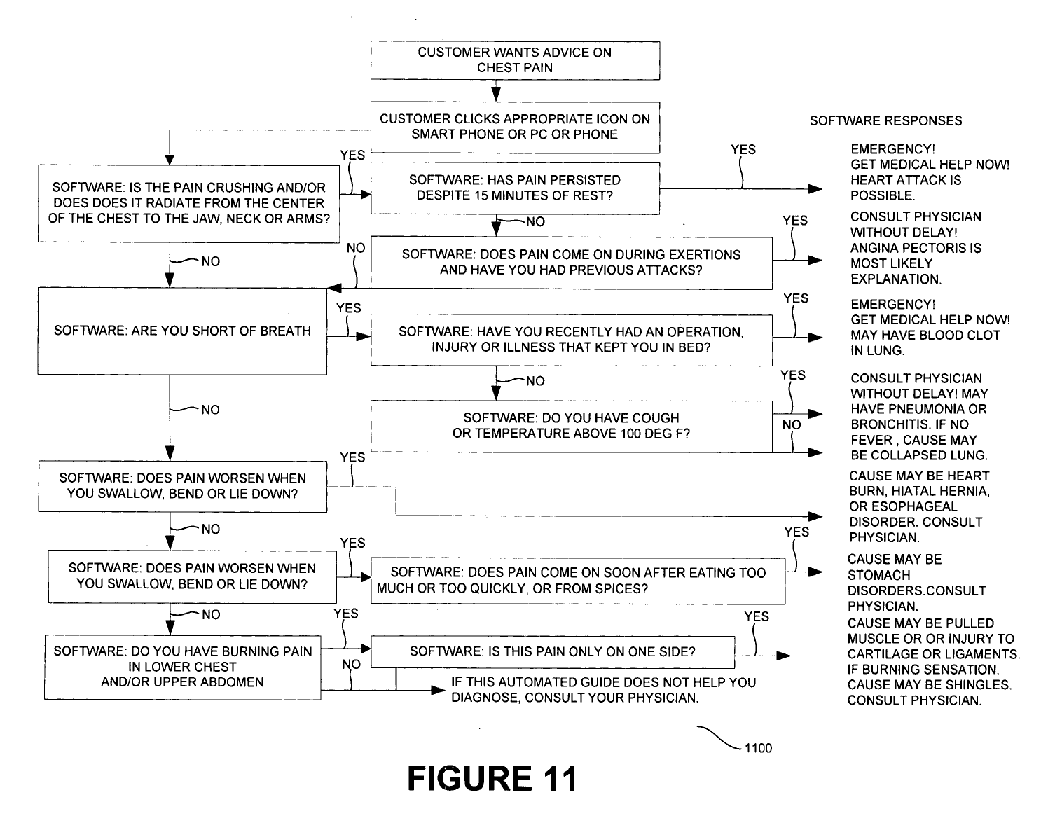

FIG. 11 is a decision tree view 1100 of advice on chest pain, according to one embodiment. The decision tree view 1100 illustrates an example embodiment of a flow of health care advice (e.g., information) based on actions and/or queries by a customer (e.g., a customer seeking health care advice on a particular symptom such as chest pain).

For example, based on an action (e.g., an action associated with selecting a health care inquiry category and/or a symptom) by the customer (e.g., communicated by the customer using a device such as a smart phone, a personal computer or a phone), a menu of choices associated with the customer's query may be generated. The menu of choices may be questions related to the query to which the customer may respond with an affirmative or negative option, as illustrated in the example embodiment of FIG. 11.

Based on the customer's responses to a cumulative and/or hierarchical sequence of choices, the decision tree view 1100 may suggest (e.g., generate using software, algorithms, links, etc.) a health care advisory action (e.g., health care advice) tailored to addressing the nature, scope, location and/or intensity of the specific symptoms identified by the customer (e.g., symptoms related to chest pain, as illustrated in the example embodiment of FIG. 11).

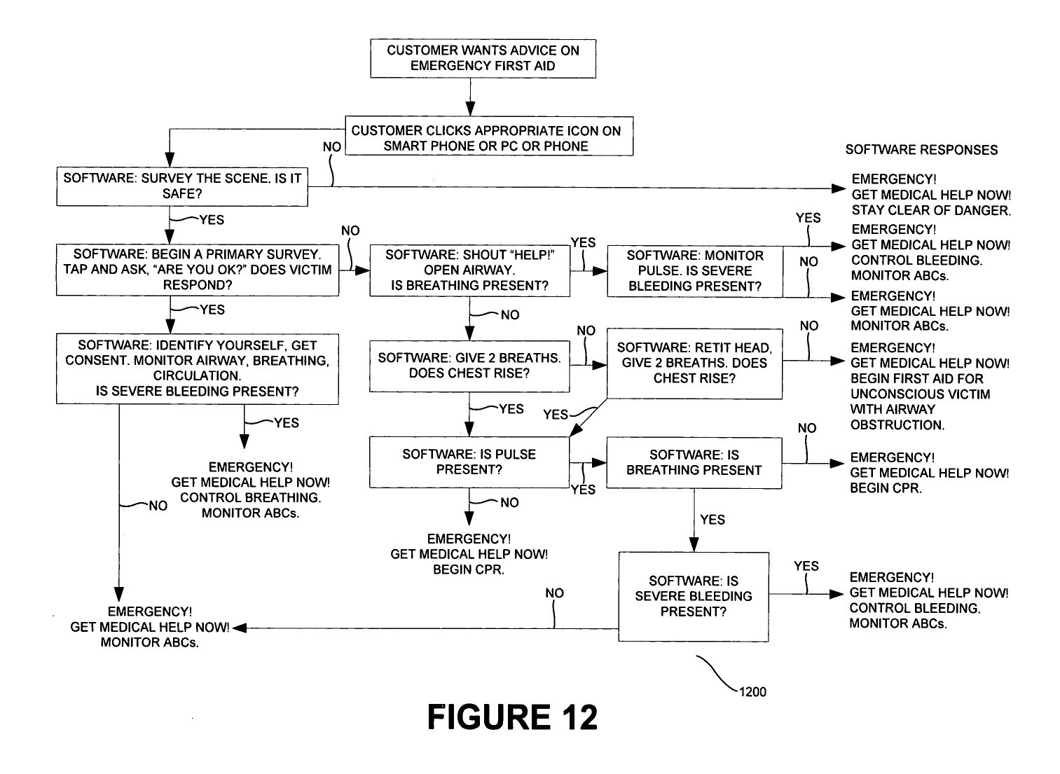

FIG. 12 is a decision tree view 1200 of advice on emergency first aid, according to one embodiment. The decision tree view 1200 illustrates an example embodiment of a flow of health care advice (e.g., information) based on actions and/or queries by a customer (e.g., a customer seeking health care advice on emergency first aid).

For example, based on an action (e.g., an action associated with selecting a health care inquiry category and/or a symptom) by the customer (e.g., communicated by the customer using a device such as a smart phone, a personal computer or a phone), a menu of choices associated with the customer's query may be generated. The menu of choices may be questions related to the query to which the customer may respond with an affirmative or negative option, as illustrated in the example embodiment of FIG. 12.

Based on the customer's responses to a cumulative and/or hierarchical sequence of choices, the decision tree view 1200 may suggest (e.g., generate using software, algorithms, links, etc.) a health care advisory action (e.g., health care advice) tailored to addressing the nature, scope, location and/or intensity of the specific conditions identified by the customer (e.g., conditions associated with providing emergency first aid, as illustrated in the example embodiment of FIG. 12).

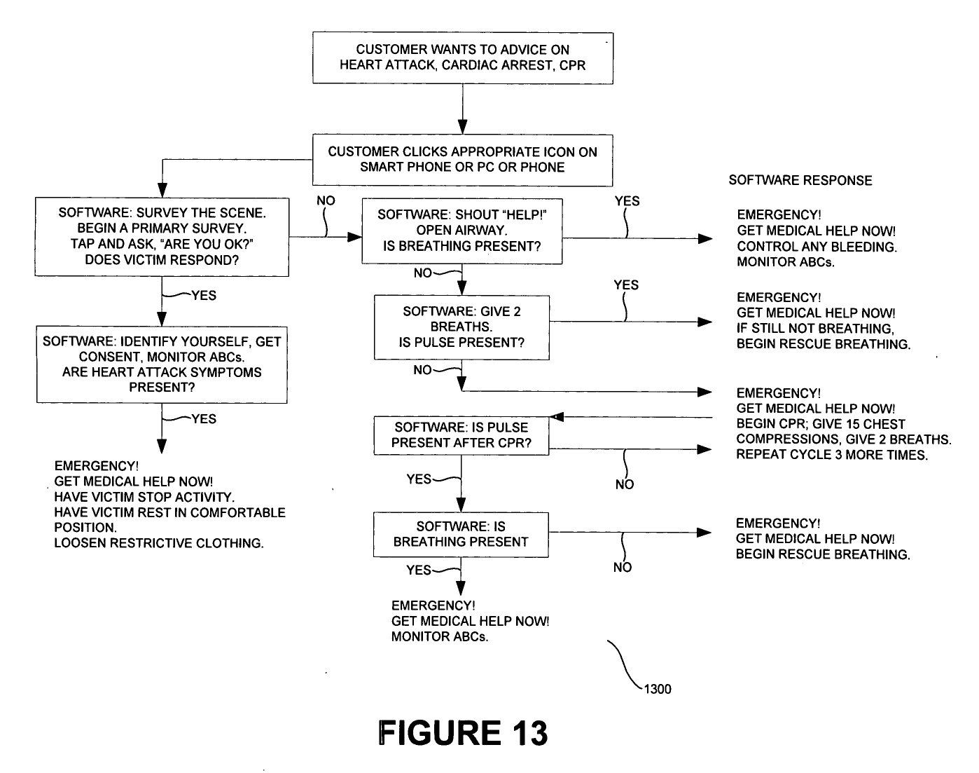

FIG. 13 is a decision tree view 1300 of advice on heart attack, cardiac arrest, and Cardio-Pulmonary Resuscitation (CPR), according to one embodiment. The decision tree view 1300 illustrates an example embodiment of a flow of health care advice (e.g., information) based on actions and/or queries by a customer (e.g., a customer seeking health care advice on heart attack, cardiac arrest, and CPR).

For example, based on an action (e.g., an action associated with selecting a health care inquiry category and/or a symptom) by the customer (e.g., communicated by the customer using a device such as a smart phone, a personal computer or a phone), a menu of choices associated with the customer's query may be generated. The menu of choices may be questions related to the query to which the customer may respond with an affirmative or negative option, as illustrated in the example embodiment of FIG. 13.

Based on the customer's responses to a cumulative and/or hierarchical sequence of choices, the decision tree view 1300 may suggest (e.g., generate using software, algorithms, links, etc.) a health care advisory action (e.g., health care advice) tailored to addressing the nature, scope, location and/or intensity of the specific symptoms and/or conditions identified by the customer (e.g., symptoms and/or conditions associated with a heart attack, cardiac arrest, or providing CPR, as illustrated in the example embodiment of FIG. 13).

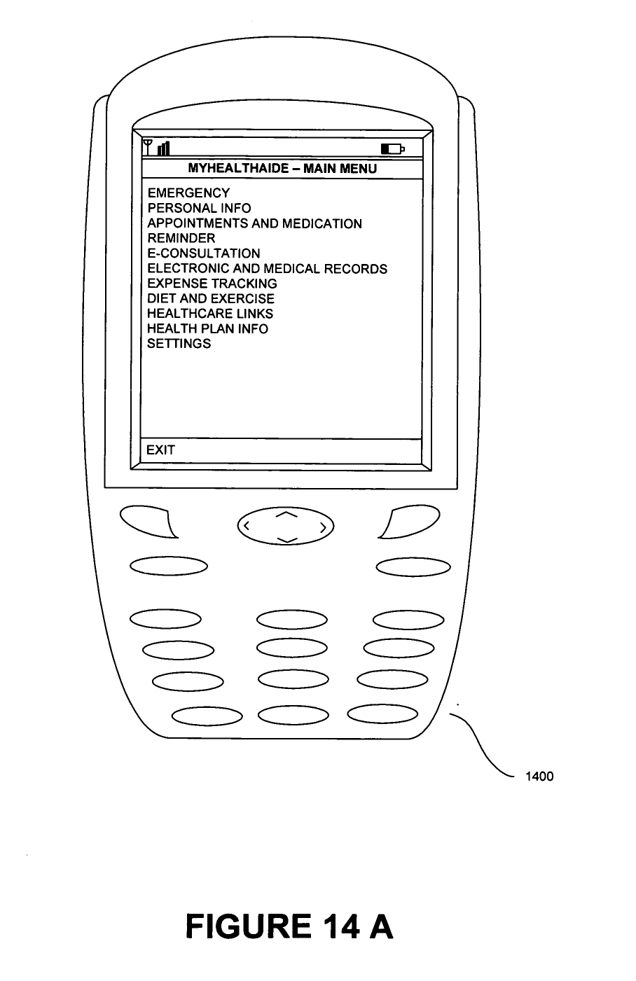

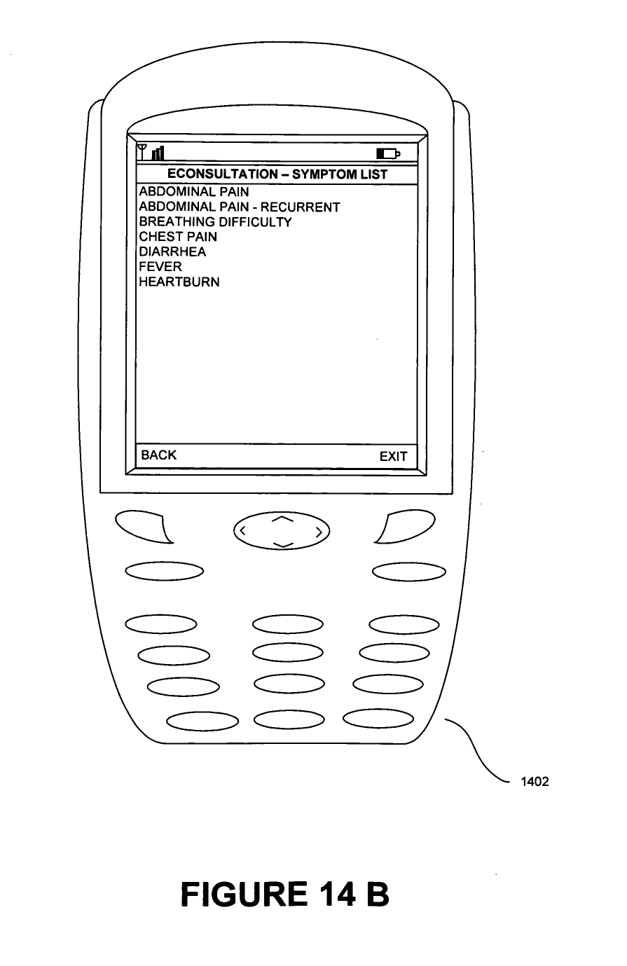

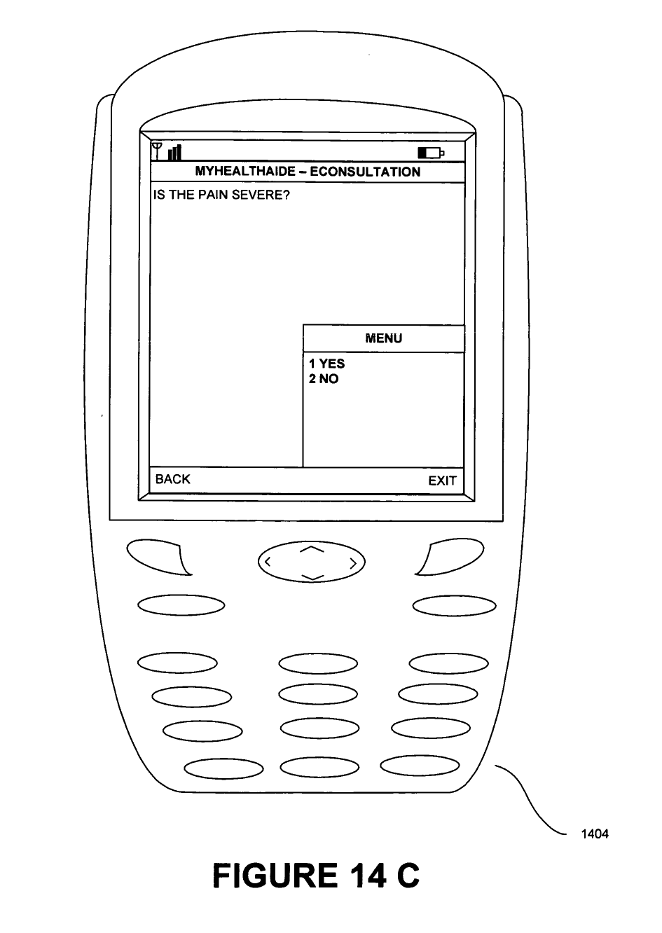

FIG. 14A-C are user interface flows (e.g., a user interface view 1400, a user interface view 1402, and a user interface view 1404 of the personal communication module 102 of FIG. 1 illustrating an e-consultation (e.g., an electronic consultation) process, according to one embodiment. In FIG. 14A, a ‘MYHEALTHAIDE-MAIN MENU’ is illustrated. The ‘MYHEALTHAIDE-MAIN MENU’ is illustrated in an example embodiment in FIG. 14A as including a set of choices including emergency, personal information, appointments and medication reminder, e-consultation (e.g., electronic consultation), electronic and medical records, expense tracking, diet and exercise, healthcare links, health plan information, and/or settings. In alternative embodiments, the display of choices may be different, and additional choices may be present.

FIG. 14B may be an illustration of the user interface view 1402 when a user selects e-consultation from the ‘MYHEALTHAIDE-MAIN MENU’ as described in FIG. 14A. An ‘ECONSULTATION-SYMPTOM LIST’ is illustrated in the embodiment of FIG. 14B. Particularly, illustrated are a number symptoms and/or conditions that might afflict the user of a personal communication module (e.g., the personal communication module 102 as illustrated in FIG. 1). These symptoms as illustrated in FIG. 14B include abdominal pain (basic and recurrent), breathing difficulty, chest pain, diarrhea, fever, and/or heartburn. In alternative embodiments, the display of choices may be different, and additional choices may be present.

FIG. 14C may be an illustration of the user interface view 1404 when a user selects one of the symptoms as described in FIG. 14B. A question ‘Is the pain severe?’ is illustrated in the embodiment of FIG. 14C. The user of the personal communication module (e.g., the personal communication module 102 as illustrated in FIG. 1) may select ‘Yes’ or ‘No’ from this screen. These symptoms and flows may vary and may differ based upon various criteria as defined by a service provider and/or user. For example, additional fields may be shown and additional screens may be presented to the user.

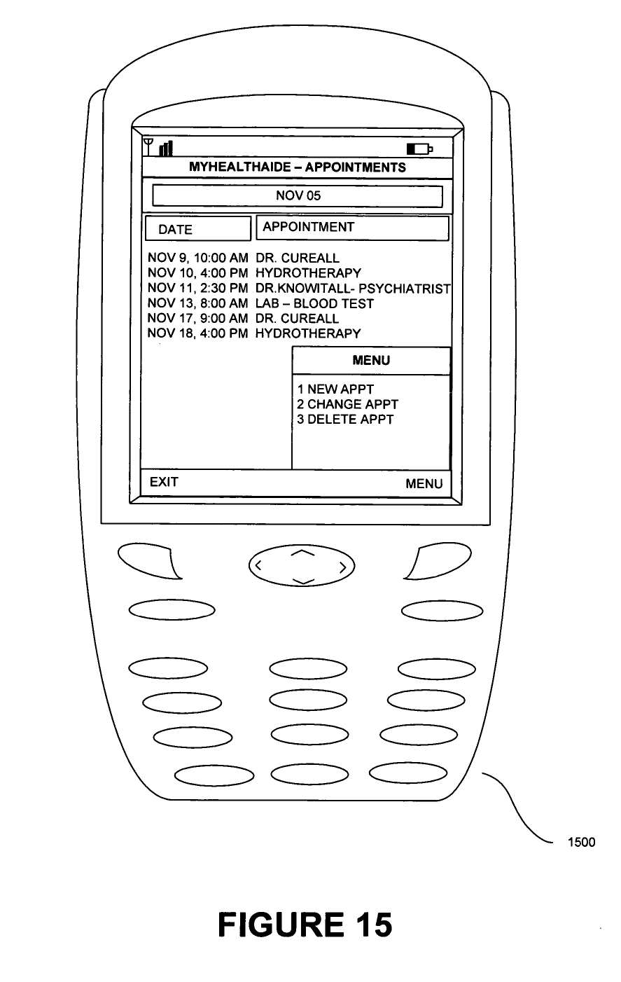

FIG. 15 is a user interface view 1500 of the personal communication module 102 of FIG. 1 illustrating an appointment calendar, according to one embodiment. A number of appointments are illustrated in the user interface view 1500 of FIG. 15, each of which is associated with a particular day and/or time at which the user has an appointment with a health care provider. In addition, a date calendar is displayed by month, and a menu may be presented to the user to enable the user to select a new appointment, a change in appointment, and/or a deletion of an appointment with one or more healthcare providers. In alternative embodiments, the display of choices may be different, and additional choices may be present.

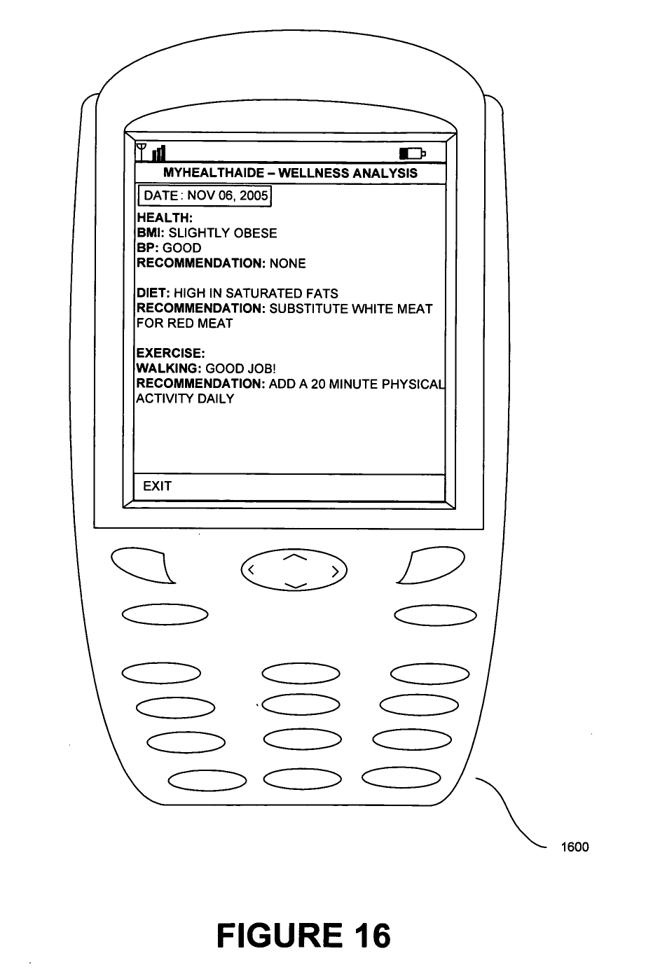

FIG. 16 a user interface view of the personal communication module 102 of FIG. 1 illustrating a wellness analysis, according to one embodiment. The wellness analysis as illustrated in FIG. 16 includes a number of input choices that a user may select. For example, in the embodiment illustrated in FIG. 16, a health, a body mass index (BMI), a blood pressure (BP), a diet, and an exercise information is displayed to the user. Various recommendations may be automatically provided with each metric to the user through the personal communication module 102 as illustrated in FIG. 16. In alternative embodiments, the display of choices may be different, and additional choices may be present.

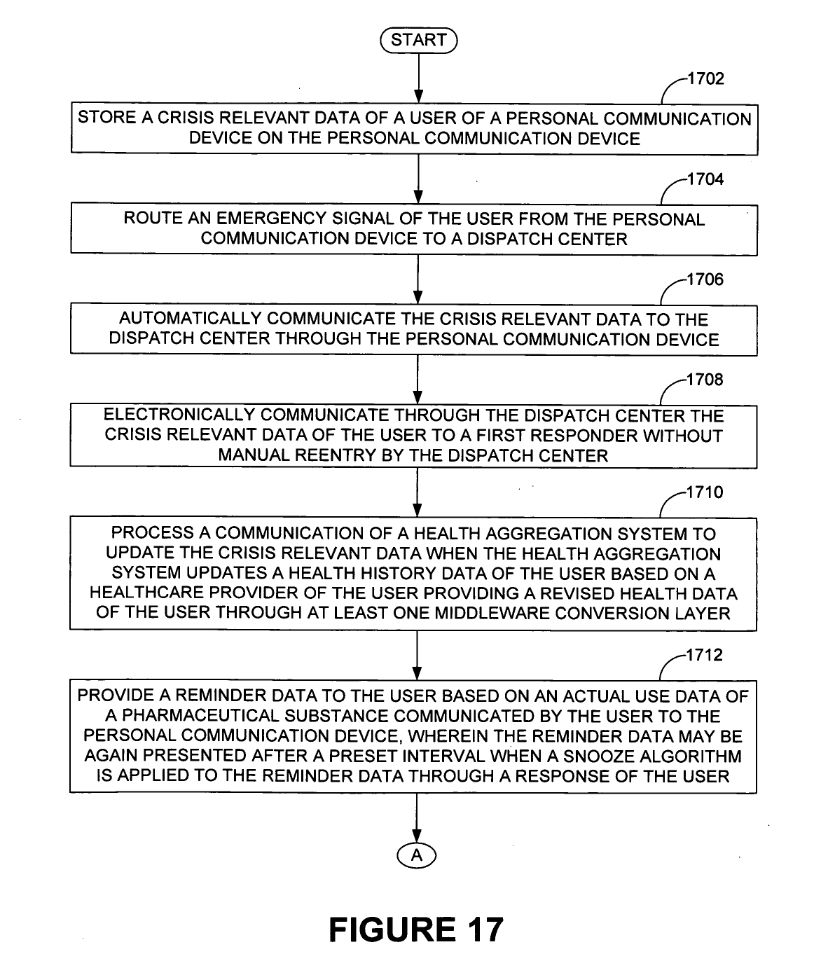

FIG. 17 is a process flow of storing a crisis relevant data of a user of a personal communication module on the personal communication module, according to one embodiment. In operation 1702, a crisis relevant data (e.g., the crisis relevant data 310, 500 of FIGS. 3, 5) of a user (e.g., the user 114 of FIG. 1) of a personal communication module (e.g., the personal communication module 102 of FIG. 1-2, 8) may be stored on the personal communication module (e.g., the personal communication module 102 of FIG. 1-2, 8). In operation 1704, an emergency signal of the user (e.g., the user 114 of FIG. 1) may be routed from the personal communication module (e.g., the personal communication module 102 of FIG. 1-2, 8) to a dispatch center (e.g., the dispatch center module 110 of FIG. 1). In operation 1706, the crisis relevant data (e.g., the crisis relevant data 310, 500 of FIGS. 3, 5) may be automatically communicated to the dispatch center (e.g., the dispatch center module 10 of FIG. 1) through the personal communication module (e.g., the personal communication module 102 of FIG. 1-2, 8).

In operation 1708, through the dispatch center the crisis relevant data (e.g., the crisis relevant data 310, 500 of FIGS. 3, 5) of the user (e.g., the user 114 of FIG. 1) may be electronically communicated to a first responder (e.g., the first responder module 112 of FIG. 1) without manual reentry (e.g., and/or communication) by the dispatch center (e.g., the dispatch center module 110 of FIGS. 1, 5). In operation 1710, a communication of a health aggregation system may be processed to update the crisis relevant data (e.g., the crisis relevant data 310, 500 of FIGS. 3, 5) when the health aggregation system updates a health history data of the user based on a healthcare provider (e.g., the health care provider module 106A-N, 106 of FIGS. 1, 8) of the user (e.g., the user 114 of FIG. 1) providing a revised health data of the user (e.g., the user 114 of FIG. 1) through at least one middleware (e.g., the middleware module 304 of FIGS. 3, 8) conversion layer.

In operation 1712, a reminder data may be provided to the user (e.g., the user 114 of FIG. 1) based on an actual use data of a pharmaceutical substance communicated by the user (e.g., the user 114 of FIG. 1) to the personal communication module (e.g., the personal communication module 102 of FIG. 1-2), wherein the reminder data may be again presented after a preset interval when a snooze algorithm is applied to the reminder data through a response of the user (e.g., the user 114 of FIG. 1).

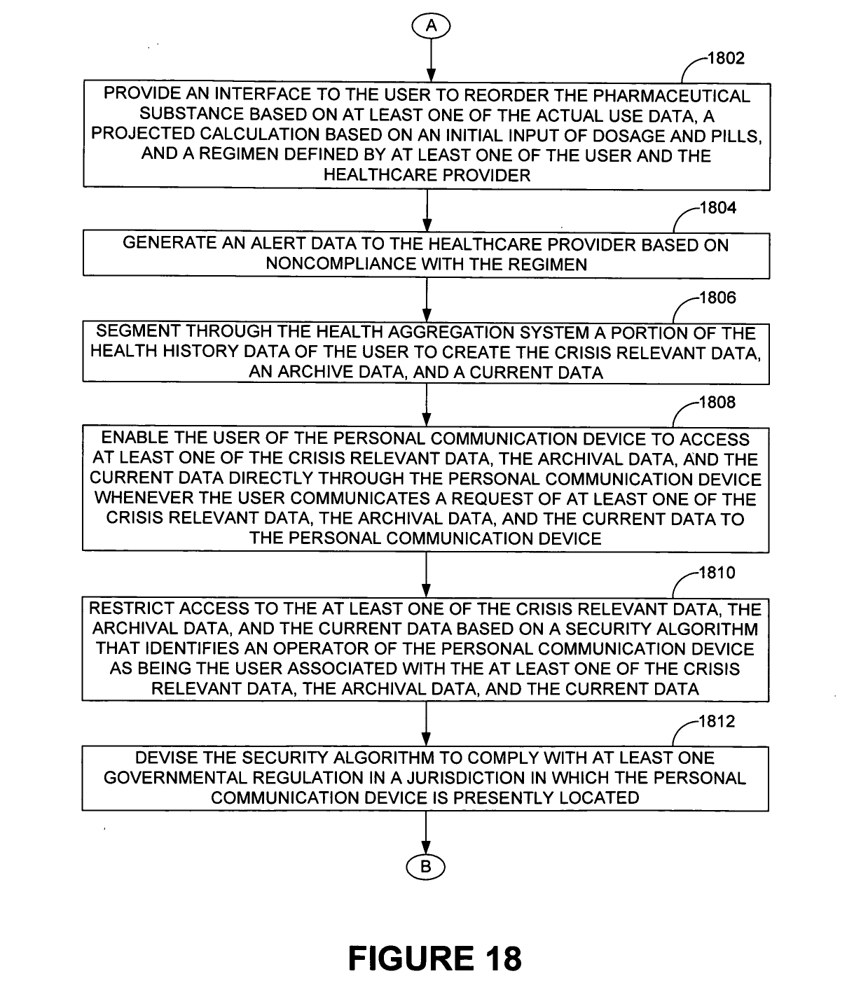

FIG. 18 is a continuation of the process flow of FIG. 17 illustrating additional processes, according to one embodiment. In operation 1802, an interface to the user (e.g., the user 114 of FIG. 1) may be provided to reorder the pharmaceutical substance based on at least one of the actual use data, a projected calculation based on an initial input of dosage and pills, and a regimen defined by at least one of the user (e.g., the user 114 of FIG. 1) and the healthcare provider (e.g., the health care provider module 106A-N, 106 of FIGS. 1, 8).

In operation 1804, an alert data may be generated to the healthcare provider (e.g., the health care provider module 106A-N, 106 of FIGS. 1, 8) based on noncompliance with the regimen. In operation 1806, the health aggregation system may be segmented through a portion of the health history data of the user (e.g., the user 114 of FIG. 1) to create the crisis relevant data (e.g., the crisis relevant data 310, 500 of FIGS. 3, 5), an archival data (e.g., the archival data 312 of FIG. 3), and a current data (e.g., the current data 314 of FIG. 3).

In operation 1808, the user (e.g., the user 114 of FIG. 1) of the personal communication module (e.g., the personal communication module 102 of FIG. 1-2, 8) may be enabled to access at least one of the crisis relevant data (e.g., the crisis relevant data 310, 500 of FIGS. 3, 5), the archival data, and the current data directly through the personal communication module (e.g., the personal communication module 102 of FIG. 1-2, 8) whenever the user (e.g., the user 114 of FIG. 1) communicates a request of at least one of the crisis relevant data (e.g., the crisis relevant data 310, 500 of FIGS. 3, 5), the archival data 312, and the current data 314 to the personal communication module (e.g., the personal communication module 102 of FIG. 1-2, 8).

In operation 1810, access to the at least one of the crisis relevant data (e.g., the crisis relevant data 310, 500 of FIGS. 3, 5), the archival data 312, and the current data 314 may be restricted based on a security algorithm that identifies an operator of the personal communication module (e.g., the personal communication module 102 of FIG. 1-2, 8) as being the user (e.g., the user 114 of FIG. 1) associated with the at least one of the crisis relevant data (e.g., the crisis relevant data 310, 500 of FIGS. 3, 5), the archival data 312, and the current data 314.

In operation 1812, a security algorithm may be devised to comply with at least one governmental regulation in a jurisdiction in which the personal communication module (e.g., the personal communication module 102 of FIG. 1-2, 8) is presently located.

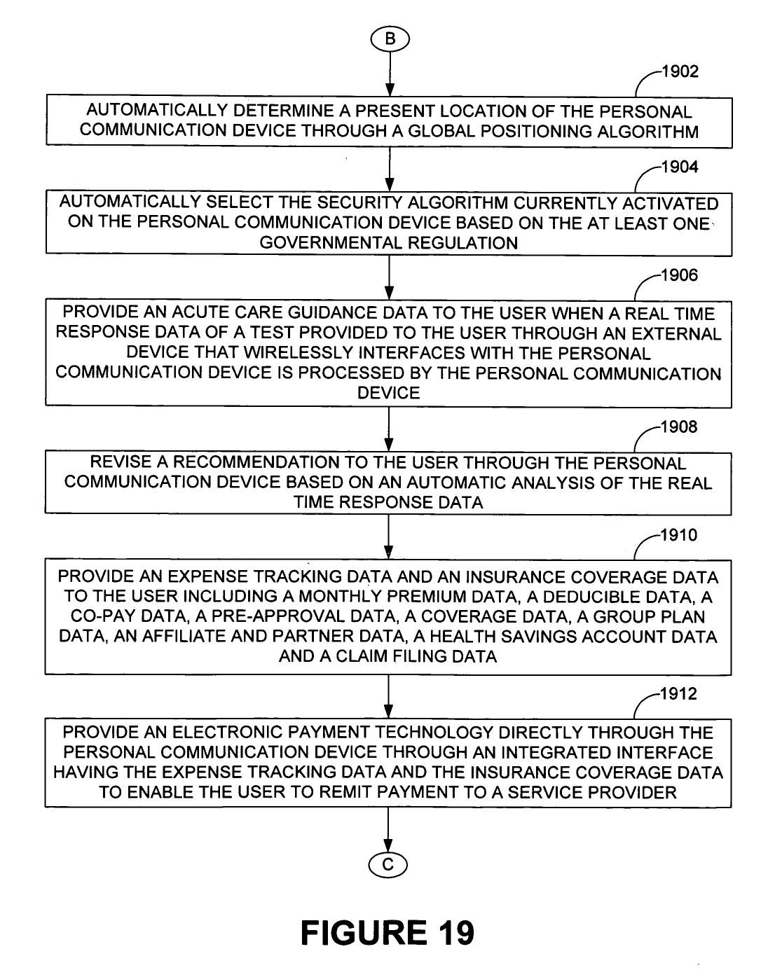

FIG. 19 is a continuation of the process flow of FIG. 18 illustrating additional processes, according to one embodiment. In operation 1902, a present location of the personal communication module (e.g., the personal communication module 102 of FIG. 1-2, 8) may be automatically determined through a global positioning algorithm (e.g., the global positioning module 214 of FIG. 2). In operation 1904, the security algorithm currently activated on the personal communication module (e.g., the personal communication module 102 of FIG. 1-2, 8) may be automatically selected based on the at least one governmental regulation.

In operation 1906, an acute care guidance data may be provided to the user (e.g., the user 114 of FIG. 1) when a real time response data of a test provided to the user (e.g., the user 114 of FIG. 1) through an external device (e.g., the external device 116 of FIG. 1) that wirelessly interfaces with the personal communication module (e.g., the personal communication module 102 of FIG. 1-2, 8) is processed by the personal communication module (e.g., the personal communication module 102 of FIG. 1-2, 8).

In operation 1908, a recommendation to the user may be revised through the personal communication module (e.g., the personal communication module 102 of FIG. 1-2, 8) based on an automatic analysis of the real time response data. In operation 1910, an expense tracking data (e.g., the expense tracking module 218 of FIG. 2) and an insurance coverage data may be provided to the user (e.g., the user 114 of FIG. 1) including a monthly premium data, a deductable data, a co-pay data, a pre-approval data, a coverage data, a group plan data, an affiliate and partner data, a health savings account data and a claim filing data. In operation 1912, an electronic payment technology may be provided directly through the personal communication module (e.g., the personal communication module 102 of FIG. 1-2, 8) through an integrated interface having the expense tracking data (e.g., the expense tracking module 218 of FIG. 2) and the insurance coverage data to enable the user (e.g., the user 114 of FIG. 1) to remit payment to a service provider.

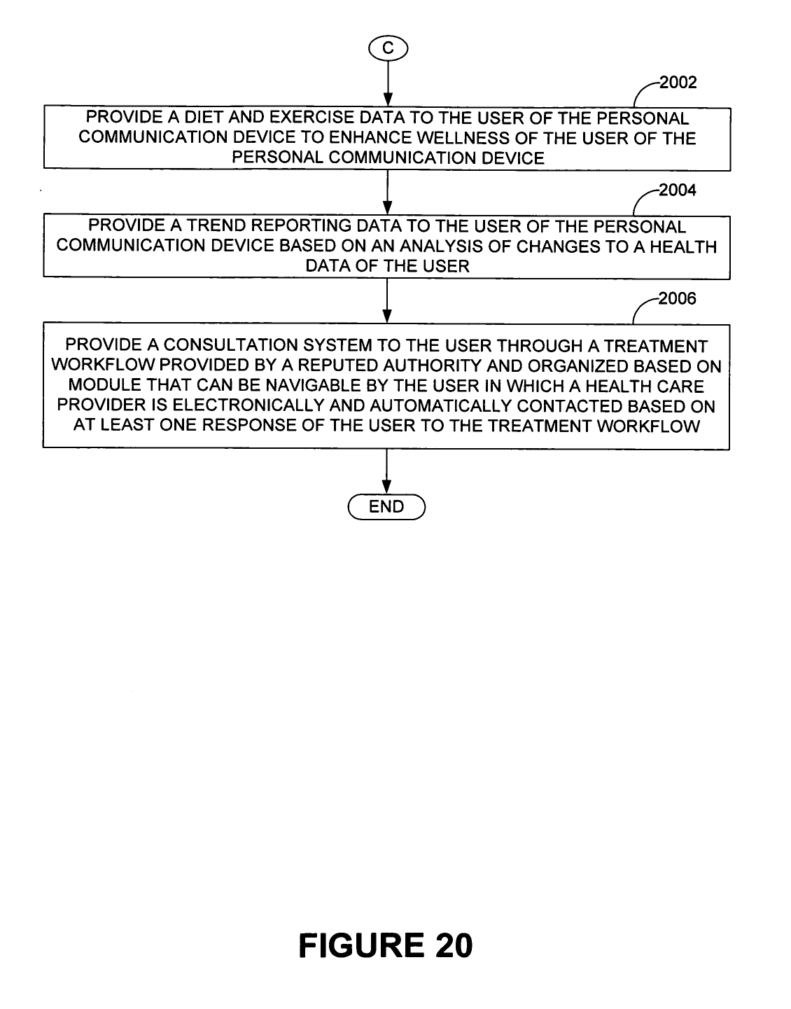

FIG. 20 is a continuation of the process flow of FIG. 19 illustrating additional processes, according to one embodiment. In operation 2002, a diet and exercise data may be provided to the user (e.g., the user 114 of FIG. 1) of the personal communication module (e.g., the personal communication module 102 of FIG. 1-2, 8) to enhance wellness of the user (e.g., the user 114 of FIG. 1) of the personal communication module (e.g., the personal communication module 102 of FIG. 1-2, 8). In operation 2004, a trend reporting data may be provided to the user (e.g., the user 114 of FIG. 1) of the personal communication module (e.g., the personal communication module 102 of FIG. 1-2, 8) based on an analysis of changes to a health data of the user (e.g., the user 114 of FIG. 1).

In operation 2006, a consultation system may be provided to the user (e.g., the user 114 of FIG. 1) through a treatment workflow provided by a reputed authority and organized based on module that can be navigable by the user (e.g., the user 114 of FIG. 1) in which a health care provider (e.g., the health care provider module 106A-N, 106 of FIGS. 1, 8) is electronically and automatically contacted based on at least one response of the user (e.g., the user 114 of FIG. 1) to the treatment workflow.

The various modules, circuits, and/or systems disclosed herein may be performed in hardware and/or software code. For example the modules disclosed herein may be enabled and operated using hardware circuitry (e.g., CMOS based logic circuitry), firmware, software and/or any combination of hardware, firmware, and/or software (e.g., embodied in a machine readable medium). Similarly, the modules disclosed herein may be enabled using software programming techniques.

Particularly, the health vault module 100, the personal communication module 102, the healthcare provider module 106, the dispatch center module 110, the first responder 112 and the external device 116 of FIG. 1, the update module 200, the reminder module 202, the routing module 204, the crisis module 206, the UI module 208, the reorder module 210, the acute care module 212, the global positioning module 214, the security module 216, the expense tracking module 218, the compliance module 220, the alert module 222, the snooze module 224, the trending module 226, the consultation module 228, the navigation analysis module 230, the wellness module 232 and the advisory module 234 of FIG. 2, and the reporting administration module 300, the data capture module 302, the middleware module 304, the data organizer module 306, the personal health database 308, the appointment schedule module 316, the legal health data module 318 and the reputed authority module 320 of FIG. 3 may be enabled using software and/or using transistors, logic gates, and electrical circuits (e.g., application specific integrated ASIC circuitry) such as a health vault circuit, a personal communication circuit, a healthcare provider circuit, a dispatch circuit, a first responder circuit, an external circuit, an update circuit, a reminder circuit, a routing circuit, a crisis circuit, a UI circuit, a reorder circuit, an acute care circuit, a global positioning circuit, a security circuit, an expense tracking circuit, a compliance circuit, an alert circuit, a snooze circuit, a trending circuit, a consultation circuit, a navigation analysis circuit, a wellness circuit, an advisory circuit, a reporting administration circuit, a data capture circuit, a middleware circuit, a data organizer circuit, a personal health circuit, an appointment schedule circuit, a legal health data circuit and a reputed authority circuit.

Although the present embodiments have been described with reference to specific example embodiments, it will be evident that various modifications and changes may be made to these embodiments without departing from the broader spirit and scope of the various embodiments.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method, comprising:
storing a crisis relevant data of a user of a personal communication module on the personal communication module;
routing an emergency signal of the user from the personal communication module to a dispatch center; and
automatically communicating the crisis relevant data to the dispatch center through the personal communication module.

2. The method of claim 1 further comprising electronically communicating through the dispatch center the crisis relevant data of the user to a first responder without manual reentry by the dispatch center.

3. The method of claim 2 wherein the crisis relevant data aids the first responder in assessing a condition of the user in an emergency scenario.

4. The method of claim 2 further comprising processing a communication of a health aggregation system to update the crisis relevant data when the health aggregation system updates a health history data of the user based on a healthcare provider of the user providing a revised health data of the user through at least one middleware conversion layer.

5. The method of claim 4 wherein the health aggregation system includes a legal health data of the user including a healthcare power of attorney, a will, a trust, and other relevant corpus and res data of the user.

6. The method of claim 4 further comprising providing a reminder data to the user based on an actual use data of a pharmaceutical substance communicated by the user to the personal communication module, wherein the reminder data may be again presented after a preset interval when a snooze algorithm is applied to the reminder data through a response of the user.

7. The method of claim 6 wherein the reminder data is also provided based on an appointment schedule between the healthcare provider and the user maintained by the health aggregation system.

8. The method of claim 6 further comprising providing an interface to the user to reorder the pharmaceutical substance based on at least one of the actual use data, a projected calculation based on an initial input of dosage and pills, and a regimen defined by at least one of the user and the healthcare provider.

9. The method of claim 8 further comprising generating an alert data to the healthcare provider based on noncompliance with the regimen.

10. The method of claim 4 further comprising segmenting through the health aggregation system a portion of the health history data of the user to create the crisis relevant data, an archival data, and a current data.

11. The method of claim 10 further comprising enabling the user of the personal communication module to access at least one of the crisis relevant data, the archival data, and the current data directly through the personal communication module whenever the user communicates a request of at least one of the crisis relevant data, the archival data, and the current data to the personal communication module.

12. The method of claim 11 further comprising restricting access to the at least one of the crisis relevant data, the archival data, and the current data based on a security algorithm that identifies an operator of the personal communication module as being the user associated with the at least one of the crisis relevant data, the archival data, and the current data.

13. The method of claim 12 applying the security algorithm using a biometric information provided by the operator of the personal communication module comprising at least one of an auditory data, a visual data, and a tactile data.

14. The method of claim 13 further comprising devising the security algorithm to comply with at least one governmental regulation in a jurisdiction in which the personal communication module is presently located.

15. The method of claim 14 further comprising automatically determining a present location of the personal communication module through a global positioning algorithm.

16. The method of claim 15 further comprising automatically selecting the security algorithm currently activated on the personal communication module based on the at least one governmental regulation.

17. The method of claim 1 further comprising:
providing an acute care guidance data to the user when a real time response data of a test provided to the user through an external device that wirelessly interfaces with the personal communication module is processed by the personal communication module; and
revising a recommendation to the user through the personal communication module based on an automatic analysis of the real time response data.

18. The method of claim 17 wherein the external device is at least one of a blood pressure measurement device, a blood sugar measurement device, a temperature monitoring device, a heart rate monitoring device, a blood oxygenation device, a vital sign measuring device, and a sensory measurement device.

19. The method of claim 1 further comprising providing an expense tracking data and an insurance coverage data to the user including a monthly premium data, a deductible data, a co-pay data, a pre-approval data, a coverage data, a group plan data, an affiliate and partner data, a health savings account data and a claim filing data.

20. The method of claim 19 further comprising providing an electronic payment technology directly through the personal communication module through an integrated interface having the expense tracking data and the insurance coverage data to enable the user to remit payment to a service provider.

21. The method of claim 1 further comprising:
providing a diet and exercise data to the user of the personal communication module to enhance wellness of the user of the personal communication module; and
providing a trend reporting data to the user of the personal communication module based on an analysis of changes to a health data of the user.

22. The method of claim 1 further comprising providing a consultation system to the user through a treatment workflow provided by a reputed authority and organized based on module that can be navigable by the user in which a health care provider is electronically and automatically contacted based on at least one response of the user to the treatment workflow.

23. The method of claim 22 wherein a transcript of response to the consultation system by the user is automatically provided to the health care provider.

24. The method of claim 22 wherein the consultation system to automatically display certain modules of the treatment workflow in a more quickly accessible location on the personal communication module through an analysis of historical navigation and selection data of the user.

25. The method of claim 22 wherein a symptom list is automatically created based on an outbreak in a geographic area of a virus, bacteria, or health alert.

26. The method of claim 22 wherein a travel advisory is provided through the consultation system to the user based on a geographic positioning system in the personal communication module.

27. The method of claim 1 in a form of a machine-readable medium embodying a set of instructions that, when executed by a machine, causes the machine to perform the method of claim 1.

28. A personal communication module, comprising:
a crisis module having an emergency relevant data of a primary user of the personal communication module;
an update module to automatically bring up to date the emergency relevant data based on a communication with a health vault module having profile information of a plurality of patients including the primary user of the personal communication module; and
a routing module to automatically communicate the emergency relevant data to at least one of a dispatch center and a first responder when an emergency situation is detected by the personal communication module.

29. The personal communication module of claim 28 wherein the health vault module aggregates a health data of the primary user from a plurality of historical and current health care providers of the primary user, and wherein each of the plurality of historical and current health care providers are provided a tailored interface module to provide the health data of the primary user to the health vault module.

30. The personal communication module of claim 29 wherein any of the health data of the primary user is accessible by the primary user through the personal communication module.

31. A system comprising:
a plurality of health care providers of a user each to share a crisis relevant data, an archival data, and a current data of the user with a health vault module;
a network; and
a personal communication module carried on a person of the user to communicate with the health vault module through the network, and through which is provided at least one of the crisis relevant data, the archival data, and the current data to the user on demand of the user through the personal communication module.

32. The system of claim 31 comprising a dispatch center to automatically process the crisis relevant data of the user when the dispatch center is notified of an emergency situation affecting the user of the personal communication module.

33. The system of claim 31 wherein the health vault module to provide a diet and exercise data to the user of the personal communication module to enhance wellness of the user of the personal communication module; and wherein the health vault module to provide a trend reporting data to the user of the personal communication module based on an analysis of changes to a health data of the user that is at least one of voluntarily inputted by the user or provided by the plurality of health care providers to the health vault module.
